(19) United States
(12) Patent Application Publication
(10) Pub. No.: US 2020/0399158 A1
(43) Pub. Date: Dec. 24, 2020

(54) METHODS AND APPARATUS FOR MANUFACTURING A GLASS RIBBON

(71) Applicant: Corning Incorporated, Corning, NY (US)

(72) Inventors: Bethany Jon ALDERMAN, Bath, NY (US); Naigeng CHEN, San Jose, CA (US); Claire Renata COBLE, Horseheads, NY (US); Peter Joseph LEZZI, Corning, NY (US); Yousef Kayed QAROUSH, Painted Post, NY (US); Elizabeth Mary STURDEVANT, Corning, NY (US)

(21) Appl. No.: 16/906,348

(22) Filed: Jun. 19, 2020

Related U.S. Application Data
(60) Provisional application No. 62/864,145, filed on Jun. 20, 2019.

(51) Int. Cl. C03B 18/12; C03B 18/14; G02F 1/1333; C03C 15/00

(52) U.S. Cl. CPC C03B 18/12; C03C 15/00; G02F 1/1333; C03B 18/14

(57) ABSTRACT

A glass ribbon includes a first major surface extending along a first plane. The glass ribbon includes a second major surface extending along a second plane substantially parallel to the first plane. A first thickness is defined between the first major surface and the second major surface along a thickness direction perpendicular to the first major surface. The first thickness is within a range from about 25 μm to about 125 μm. An edge surface extends between the first plane and the second plane. The edge surface comprises a height in the thickness direction that is less than the first thickness. Methods of manufacturing a glass ribbon are also provided.

### CROSS-REFERENCE TO RELATED APPLICATION

This application claims the benefit of priority under 35 U.S.C. § 119 of U.S. Provisional Application Ser. No. 62/864,145 filed on Jun. 20, 2019, the content of which is relied upon and incorporated herein by reference in its entirety.

### FIELD

The present disclosure relates generally to methods for manufacturing a glass ribbon and, more particularly, to methods for manufacturing a glass ribbon with a tapered edge.

### BACKGROUND

Known glass ribbons can comprise a thickness from about 20 micrometers (μm or microns) to about 200 μm. Forming these glass ribbons with an edge shape can be a slow and costly process. For example, the glass ribbon may initially comprise a larger than targeted thickness. The glass ribbon may then be cut into smaller portions, stacked to process the edges and/or form other cut-out shapes in the portions, and then separated and etched to a final, target thickness. However, such a process leads to increased surface roughness and reduced optical quality. An alternative approach involves utilizing a glass ribbon that is initially at a target thickness. However, to maintain this target thickness, one or more surfaces of the glass ribbon are shielded during processing (possibly including during any stacking), which is a challenging and costly process.

### SUMMARY

There are set forth methods of manufacturing a glass ribbon, comprising masking a first region and a second region of a first major surface of the glass ribbon, such that the first major surface comprises a first exposed region between the first region and the second region. Methods comprise etching the first exposed region to separate a first ribbon portion from a second ribbon portion, and form a first tapered edge at the first ribbon portion and a second tapered edge at the second ribbon portion. By masking and etching the glass ribbon, one or more ribbon portions can be formed at a target thickness with a tapered edge shape. The glass ribbon can initially be at a target thickness or may be at a larger than target thickness. The glass ribbon may be separable into smaller ribbon portions with a tapered edge shape and a target thickness. Such a glass ribbon comprises a thickness range from about 20 μm to about 200 μm. The tapered edge of the glass ribbon can reduce a maximum stress that the glass ribbon experiences during bending.

Embodiment 1. A method of manufacturing a glass ribbon comprises masking a first region and a second region of a first major surface of the glass ribbon, such that the first major surface comprises a first exposed region between the first region and the second region. The method comprises masking a third region and a fourth region of a second major surface of the glass ribbon, such that the second major surface comprises a second exposed region between the third region and the fourth region. The method comprises etching the first exposed region and the second exposed region to separate a first ribbon portion, comprising the first region and the third region, from a second ribbon portion, comprising the second region and the fourth region, and form a first tapered edge at the first ribbon portion and a second tapered edge at the second ribbon portion.

Embodiment 2. The method of embodiment 1, further comprising forming, prior to etching, an initial groove at the first exposed region.

Embodiment 3. The method of embodiment 2, wherein the forming the initial groove comprises perforating the first exposed region at a plurality of locations.

Embodiment 4. The method of embodiment 2, wherein the forming the initial groove comprises scoring the first exposed region.

Embodiment 5. The method of any one of embodiments 1-4, wherein the etching the first exposed region and the second exposed region comprises exposing the first exposed region and the second exposed region to an etchant for a period of time until the first ribbon portion is separated from the second ribbon portion and a gap is formed between the first tapered edge of the first ribbon portion and the second tapered edge of the second ribbon portion.

Embodiment 6. The method of any one of embodiments 1-4, wherein the etching the first exposed region and the second exposed region comprises exposing the first exposed region and the second exposed region to an etchant and concluding an exposure of the first exposed region and the second exposed region to the etchant prior to the first ribbon portion separating from the second ribbon portion.

Embodiment 7. The method of embodiment 6, further comprising applying a mechanical force to the glass ribbon to separate the first ribbon portion from the second ribbon portion after concluding the exposure of the first exposed region and the second exposed region to the etchant.

Embodiment 8. The method of embodiment 7, wherein the etching the first exposed region and the second exposed region comprises, following a separation of the first ribbon portion from the second ribbon portion, exposing the first tapered edge and the second tapered edge to a second etchant.

Embodiment 9. A method of manufacturing a glass ribbon comprises forming an initial groove at one or more of a first major surface of the glass ribbon or a second major surface of the glass ribbon, the initial groove formed between a first ribbon portion of the glass ribbon and a second ribbon portion of the glass ribbon. The method comprises etching the glass ribbon to reduce a thickness of the glass ribbon and separate the first ribbon portion from the second ribbon portion along the initial groove such that a first tapered edge is formed at the first ribbon portion and a second tapered edge is formed at the second ribbon portion.

Embodiment 10. The method of embodiment 9, wherein the forming the initial groove comprises perforating the first major surface at a plurality of locations between the first ribbon portion and the second ribbon portion.

Embodiment 11. The method of embodiment 9, wherein the forming the initial groove comprises scoring the first major surface between the first ribbon portion and the second ribbon portion.

Embodiment 12. The method of any one of embodiments 9-11, wherein the etching the glass ribbon comprises exposing the first major surface and the second major surface to an etchant for a period of time until the first ribbon portion is separated from the second ribbon portion and a gap is formed between the first tapered edge of the first ribbon portion and the second tapered edge of the second ribbon portion.

Embodiment 13. The method of any one of embodiments 9-11, wherein the etching the glass ribbon comprises exposing the first major surface and the second major surface to an etchant and concluding an exposure of the first major surface and the second major surface to the etchant prior to the first ribbon portion separating from the second ribbon portion.

Embodiment 14. The method of embodiment 13, further comprising applying a mechanical force to the glass ribbon to separate the first ribbon portion from the second ribbon portion after concluding the exposure of the first major surface and the second major surface to the etchant.

Embodiment 15. A method of manufacturing a glass ribbon comprises masking a first major surface and a second major surface of the glass ribbon. The method comprises unmasking a first exposed region of the first major surface and a second exposed region of the second major surface. The method comprises forming an initial groove at one or more of the first exposed region or the second exposed region, the initial groove formed between a first ribbon portion of the glass ribbon and a second ribbon portion of the glass ribbon. The method comprises etching the first exposed region and the second exposed region to separate the first ribbon portion from the second ribbon portion along the initial groove and form a first tapered edge at the first ribbon portion and a second tapered edge at the second ribbon portion.

Embodiment 16. The method of embodiment 15, wherein the unmasking the first exposed region and the second exposed region comprises directing a laser beam towards a mask covering the first exposed region and a second mask covering the second exposed region.

Embodiment 17. The method of embodiment 16, wherein the forming the initial groove comprises directing the laser beam towards the first exposed region to perforate the first exposed region at a plurality of locations.

Embodiment 18. The method of embodiment 16, wherein the forming the initial groove comprises scoring the first exposed region.

Embodiment 19. The method of any one of embodiments 15-18, further comprising maintaining an initial thickness of the glass ribbon such that the initial thickness of the glass ribbon, defined between the first major surface and the second major surface at a first location spaced a distance apart from the first exposed region and the second exposed region, prior to etching is substantially equal to a final thickness of the first ribbon portion, defined between the first major surface and the second major surface at the first location, after etching.

Embodiment 20. The method of embodiment 19, wherein the maintaining the initial thickness of the glass ribbon comprises maintaining the initial thickness within a range from about 20 μm to about 200 μm.

Embodiment 21. A glass ribbon comprises a first major surface extending along a first plane. The glass ribbon comprises a second major surface extending along a second plane substantially parallel to the first plane. A first thickness is defined between the first major surface and the second major surface along a thickness direction perpendicular to the first major surface. The first thickness is within a range from about 25 μm to about 125 μm. The glass ribbon comprises an edge surface extending between the first plane and the second plane. The edge surface comprises a height in the thickness direction that is less than the first thickness.

Embodiment 22. The glass ribbon of embodiment 21, wherein the edge surface extends along an edge plane that is substantially perpendicular to the first plane, the edge surface spaced a first separating thickness from the first plane and a second separating thickness from the second plane.

Embodiment 23. The glass ribbon of embodiment 22, wherein the first separating thickness is substantially equal to the second separating thickness.

Embodiment 24. The glass ribbon of embodiment 21, wherein the edge surface is non-planar.

Embodiment 25. A glass ribbon comprises a first major surface extending along a first plane and a second major surface extending along a second plane substantially parallel to the first plane. A first thickness is defined between the first major surface and the second major surface along a thickness direction perpendicular to the first major surface. The first thickness is within a range from about 25 μm to about 125 μm. The glass ribbon comprises an edge surface extending between the first plane and the second plane along an edge plane that is substantially perpendicular to the first plane. The glass ribbon comprises a first intermediate surface extending between a first outer edge of the first major surface and a first outer edge of the edge surface. The glass ribbon comprises a second intermediate surface extending between a first outer edge of the second major surface and a second outer edge of the edge surface. A first separating length between the first outer edge of the first major surface and the edge plane in a direction parallel to the first major surface is within a range from about 5 μm to about 85 μm and a first separating thickness between the first outer edge of the edge surface and the first plane along a direction parallel to the edge plane is within a range from about 25 μm to about 100 μm.

Embodiment 26. The glass ribbon of embodiment 25, wherein a second separating length between the first outer edge of the second major surface and the edge plane in a direction parallel to the second major surface is within a range from about 5 μm to about 85 μm.

Embodiment 27. The glass ribbon of embodiment 26, wherein the first separating length is substantially equal to the second separating length.

Embodiment 28. The glass ribbon of any one of embodiments 25-27, wherein a second separating thickness between the second outer edge of the edge surface and the second plane along the direction parallel to the edge plane is within a range from about 25 μm to about 100 μm.

Embodiment 29. The glass ribbon of embodiment 28, wherein the first separating thickness is substantially equal to the second separating thickness.

Embodiment 30. The glass ribbon of any one of embodiments 25-29, wherein the first intermediate surface is non-parallel with the second intermediate surface.

Embodiment 31. The glass ribbon of any one of embodiments 25-30, wherein the edge surface comprises a height in the thickness direction that is less than the first thickness.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings. It is to be understood that both the foregoing general description and the following detailed description present embodiments intended to provide an overview or framework for understanding the nature and character of the embodiments disclosed herein. The accompanying drawings are included to provide further understanding, and are incorporated into and constitute a part of this specification. The drawings illustrate various embodiments of the disclosure, and together with the description explain the principles and operations thereof.

### BRIEF DESCRIPTION OF THE DRAWINGS

These and other features, embodiments and advantages are better understood when the following detailed description is read with reference to the accompanying drawings, in which:

FIG. 1 schematically illustrates example embodiments of a glass manufacturing apparatus in accordance with embodiments of the disclosure;

FIG. 2 illustrates a perspective cross-sectional view of the glass manufacturing apparatus along line 2-2 of FIG. 1 in accordance with embodiments of the disclosure;

FIG. 3 illustrates a perspective view of example embodiments of a glass ribbon in accordance with embodiments of the disclosure;

FIG. 4 illustrates a top view of example embodiments of a glass ribbon along line 4-4 of FIG. 3 in accordance with embodiments of the disclosure;

FIG. 5 illustrates a sectional view of example embodiments of a glass ribbon along line 5-5 of FIG. 4 in accordance with embodiments of the disclosure;

FIG. 6 illustrates a sectional view of example embodiments of a glass ribbon with an unmasked area of the glass ribbon exposed to an etchant in accordance with embodiments of the disclosure;

FIG. 7 illustrates a sectional view of example embodiments of a glass ribbon with a ribbon portion of the glass ribbon comprising a tapered edge in accordance with embodiments of the disclosure;

FIG. 8 illustrates a top view of example embodiments of a glass ribbon comprising an initial groove in accordance with embodiments of the disclosure

FIG. 9 illustrates a sectional view of example embodiments of a glass ribbon along line 9-9 of FIG. 8 in accordance with embodiments of the disclosure;

FIG. 10 illustrates a sectional view of example embodiments of a glass ribbon with an unmasked area of the glass ribbon exposed to an etchant in accordance with embodiments of the disclosure;

FIG. 11 illustrates a sectional view of example embodiments of a glass ribbon after exposure of an unmasked area of the glass ribbon to an etchant has concluded in accordance with embodiments of the disclosure;

FIG. 12 illustrates a sectional view of example embodiments of a glass ribbon after separating a first ribbon portion from a second ribbon portion in accordance with embodiments of the disclosure;

FIG. 13 illustrates a sectional view of example embodiments of a glass ribbon in which a tapered edge of a ribbon portion is exposed to an etchant in accordance with embodiments of the disclosure;

FIG. 14 illustrates a top view of example embodiments of a glass ribbon in which a mask covers a first major surface of the glass ribbon in accordance with embodiments of the disclosure

FIG. 15 illustrates a sectional view of example embodiments of a glass ribbon along line 14-14 of FIG. 14 in accordance with embodiments of the disclosure;

FIG. 16 illustrates a sectional view of example embodiments of a glass ribbon after removing a portion of a mask covering a major surface of the glass ribbon in accordance with embodiments of the disclosure;

FIG. 17 illustrates a sectional view of example embodiments of a glass ribbon in which an initial groove is formed in accordance with embodiments of the disclosure;

FIG. 18 illustrates an enlarged view of portions of a glass ribbon taken at view 18 of FIG. 14 in accordance with embodiments of the disclosure;

FIG. 19 illustrates a top view of example embodiments of a glass ribbon in which an initial groove is formed in a first major surface of the glass ribbon in accordance with embodiments of the disclosure;

FIG. 20 illustrates a sectional view of example embodiments of a glass ribbon along line 20-20 of FIG. 19 in accordance with embodiments of the disclosure;

FIG. 21 illustrates a sectional view of example embodiments of a glass ribbon exposed to an etchant in accordance with embodiments of the disclosure;

FIG. 22 illustrates a sectional view of example embodiments of a glass ribbon after exposure of the glass ribbon to an etchant has concluded in accordance with embodiments of the disclosure;

FIG. 23 illustrates a sectional view of example embodiments of a glass ribbon after separating a first ribbon portion from a second ribbon portion in accordance with embodiments of the disclosure;

FIG. 24 illustrates a sectional view of example embodiments of a glass ribbon after etching the glass ribbon to separate a first ribbon portion from a second ribbon portion in accordance with embodiments of the disclosure;

FIG. 25 illustrates a sectional view of example embodiments of a tapered edge of a glass ribbon in accordance with embodiments of the disclosure;

FIG. 26 illustrates a sectional view of additional embodiments of a tapered edge of a glass ribbon in accordance with embodiments of the disclosure;

FIG. 27 illustrates a perspective view of example embodiments of a glass ribbon subject to a bending test in accordance with embodiments of the disclosure;

FIG. 28 illustrates a sectional view of example embodiments of a glass ribbon along line 28-28 of FIG. 27 in accordance with embodiments of the disclosure;

FIG. 29 illustrates a plot of some embodiments of a stress of a glass ribbon with a non-tapered edge in accordance with embodiments of the disclosure;

FIG. 30 illustrates a plot of some embodiments of a stress of a glass ribbon with a non-tapered edge in accordance with embodiments of the disclosure;

FIG. 31 illustrates a plot of some embodiments of a stress of a glass ribbon with a non-tapered edge in accordance with embodiments of the disclosure;

FIG. 32 illustrates a plot of some embodiments of a stress of a glass ribbon with a tapered edge in accordance with embodiments of the disclosure;

FIG. 33 illustrates an enlarged view of some embodiments of a tapered edge of a glass ribbon taken at view 33 of FIG. 28 in accordance with embodiments of the disclosure;

FIG. 34 illustrates a plot of some embodiments of a stress of a glass ribbon with a tapered edge in accordance with embodiments of the disclosure; and

FIG. 35 illustrates an enlarged view of some embodiments of a tapered edge of a glass ribbon taken at view 33 of FIG. 28 in accordance with embodiments of the disclosure.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, this disclosure may be embodied in many different forms and should not be construed as limited to the embodiments set forth herein.

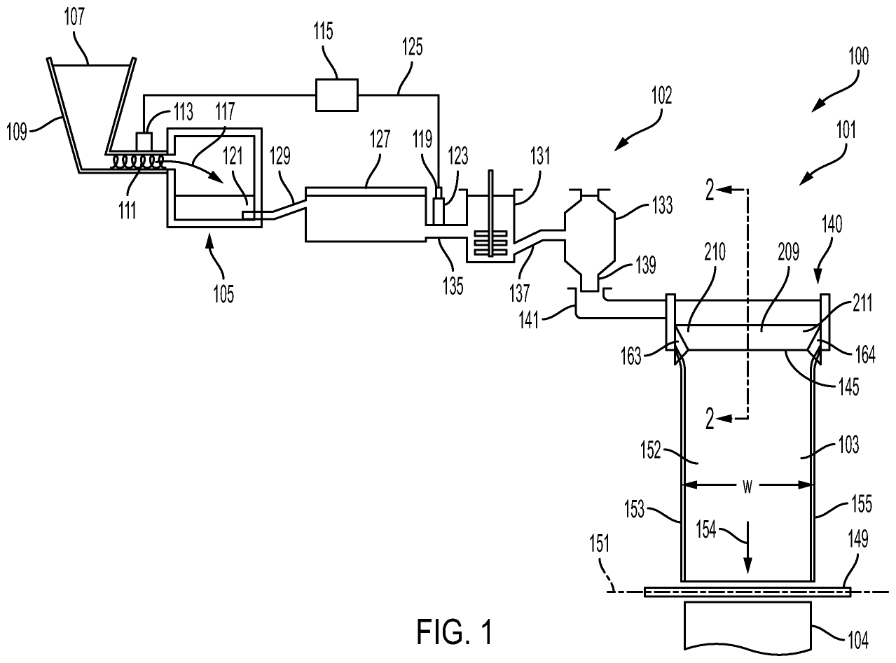

The present disclosure relates to glass manufacturing apparatus and methods for manufacturing glass. Methods and apparatus for manufacturing glass will now be described by way of example embodiments for manufacturing a glass ribbon from a quantity of molten material. As schematically illustrated in FIG. 1, in some embodiments, an exemplary glass manufacturing apparatus 100 can comprise a glass melting and delivery apparatus 102 and a forming apparatus 101 comprising a forming vessel 140 designed to produce a ribbon 103 from a quantity of molten material 121. In some embodiments, the ribbon 103 can comprise a central portion 152 positioned between opposite edge portions (e.g., edge beads) formed along a first outer edge 153 and a second outer edge 155 of the ribbon 103, wherein a thickness of the edge beads can be greater than a thickness of the central portion. Additionally, in some embodiments, a separated glass ribbon 104 can be separated from the ribbon 103 along a separation path 151 by a glass separator 149 (e.g., scribe, score wheel, diamond tip, laser, etc.). In some embodiments, before or after separation of the separated glass ribbon 104 from the ribbon 103, the edge beads formed along the first outer edge 153 and the second outer edge 155 can be removed to provide the central portion 152 as a high-quality separated glass ribbon 104 comprising a uniform thickness.

In some embodiments, the glass melting and delivery apparatus 102 can comprise a melting vessel 105 oriented to receive batch material 107 from a storage bin 109. The batch material 107 can be introduced by a batch delivery device 111 powered by a motor 113. In some embodiments, an optional controller 115 can be operated to activate the motor 113 to introduce a desired amount of batch material 107 into the melting vessel 105, as indicated by arrow 117. The melting vessel 105 can heat the batch material 107 to provide molten material 121. In some embodiments, a melt probe 119 can be employed to measure a level of molten material 121 within a standpipe 123 and communicate the measured information to the controller 115 by way of a communication line 125.

Additionally, in some embodiments, the glass melting and delivery apparatus 102 can comprise a first conditioning station comprising a fining vessel 127 located downstream from the melting vessel 105 and coupled to the melting vessel 105 by way of a first connecting conduit 129. In some embodiments, molten material 121 can be gravity fed from the melting vessel 105 to the fining vessel 127 by way of the first connecting conduit 129. For example, in some embodiments, gravity can drive the molten material 121 through an interior pathway of the first connecting conduit 129 from the melting vessel 105 to the fining vessel 127. Additionally, in some embodiments, bubbles can be removed from the molten material 121 within the fining vessel 127 by various techniques.

In some embodiments, the glass melting and delivery apparatus 102 can further comprise a second conditioning station comprising a mixing chamber 131 that can be located downstream from the fining vessel 127. The mixing chamber 131 can be employed to provide a homogenous composition of molten material 121, thereby reducing or eliminating inhomogeneity that may otherwise exist within the molten material 121 exiting the fining vessel 127. As shown, the fining vessel 127 can be coupled to the mixing chamber 131 by way of a second connecting conduit 135. In some embodiments, molten material 121 can be gravity fed from the fining vessel 127 to the mixing chamber 131 by way of the second connecting conduit 135. For example, in some embodiments, gravity can drive the molten material 121 through an interior pathway of the second connecting conduit 135 from the fining vessel 127 to the mixing chamber 131.

Additionally, in some embodiments, the glass melting and delivery apparatus 102 can comprise a third conditioning station comprising a delivery vessel 133 that can be located downstream from the mixing chamber 131. In some embodiments, the delivery vessel 133 can condition the molten material 121 to be fed into an inlet conduit 141. For example, the delivery vessel 133 can function as an accumulator and/or flow controller to adjust and provide a consistent flow of molten material 121 to the inlet conduit 141. As shown, the mixing chamber 131 can be coupled to the delivery vessel 133 by way of a third connecting conduit 137. In some embodiments, molten material 121 can be gravity fed from the mixing chamber 131 to the delivery vessel 133 by way of the third connecting conduit 137. For example, in some embodiments, gravity can drive the molten material 121 through an interior pathway of the third connecting conduit 137 from the mixing chamber 131 to the delivery vessel 133. As further illustrated, in some embodiments, a delivery pipe 139 can be positioned to deliver molten material 121 to forming apparatus 101, for example the inlet conduit 141 of the forming vessel 140.

Forming apparatus 101 can comprise various embodiments of forming vessels in accordance with features of the disclosure comprising a forming vessel with a wedge for fusion drawing the glass ribbon, a forming vessel with a slot to slot draw the glass ribbon, or a forming vessel provided with press rolls to press roll the glass ribbon from the forming vessel. By way of illustration, the forming vessel 140 shown and disclosed below can be provided to fusion draw molten material 121 off a bottom edge, defined as a root 145, of a forming wedge 209 to produce a ribbon of molten material 121 that can be drawn into the ribbon 103. For example, in some embodiments, the molten material 121 can be delivered from the inlet conduit 141 to the forming vessel 140. The molten material 121 can then be formed into the ribbon 103 based, in part on the structure of the forming vessel 140. For example, as shown, the molten material 121 can be drawn off the bottom edge (e.g., root 145) of the forming vessel 140 along a draw path extending in a draw direction 154 of the glass manufacturing apparatus 100. In some embodiments, edge directors 163, 164 can direct the molten material 121 off the forming vessel 140 and define, in part, a width “W” of the ribbon 103. In some embodiments, the width “W” of the ribbon 103 extends between the first outer edge 153 of the ribbon 103 and the second outer edge 155 of the ribbon 103.

In some embodiments, the width “W” of the ribbon 103, which extends between the first outer edge 153 of the ribbon 103 and the second outer edge 155 of the ribbon 103, can be greater than or equal to about 20 millimeters (mm), for example, greater than or equal to about 50 mm, for example, greater than or equal to about 100 mm, for example, greater than or equal to about 500 mm, for example, greater than or equal to about 1000 mm, for example, greater than or equal to about 2000 mm, for example, greater than or equal to about 3000 mm, for example, greater than or equal to about 4000 mm, although other widths less than or greater than the widths mentioned above can be provided in further embodiments. For example, in some embodiments, the width “W” of the ribbon 103 can be within a range from about 20 mm to about 4000 mm, for example, within a range from about 50 mm to about 4000 mm, for example, within a range from about 100 mm to about 4000 mm, for example, within a range from about 500 mm to about 4000 mm, for example, within a range from about 1000 mm to about 4000 mm, for example, within a range from about 2000 mm to about 4000 mm, for example, within a range from about 3000 mm to about 4000 mm, for example, within a range from about 20 mm to about 3000 mm, for example, within a range from about 50 mm to about 3000 mm, for example, within a range from about 100 mm to about 3000 mm, for example, within a range from about 500 mm to about 3000 mm, for example, within a range from about 1000 mm to about 3000 mm, for example, within a range from about 2000 mm to about 3000 mm, for example, within a range from about 2000 mm to about 2500 mm, and all ranges and subranges therebetween.

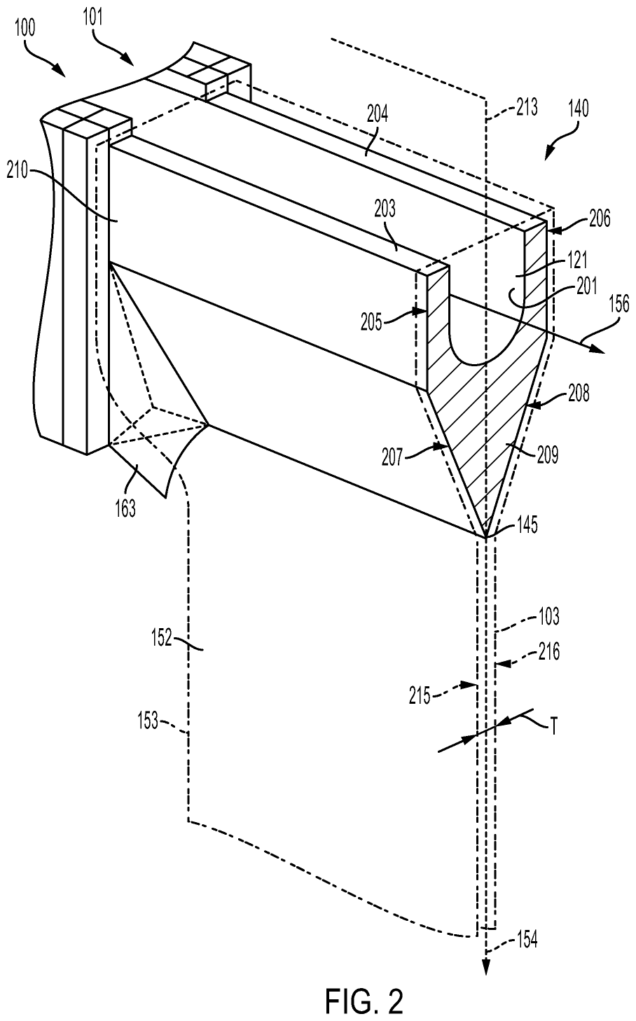

FIG. 2 shows a cross-sectional perspective view of the forming apparatus 101 (e.g., forming vessel 140) along line 2-2 of FIG. 1. In some embodiments, the forming vessel 140 can comprise a trough 201 oriented to receive the molten material 121 from the inlet conduit 141. For illustrative purposes, cross-hatching of the molten material 121 is removed from FIG. 2 for clarity. The forming vessel 140 can further comprise the forming wedge 209 comprising a pair of downwardly inclined converging surface portions 207, 208 extending between opposed ends 210, 211 (See FIG. 1) of the forming wedge 209. The pair of downwardly inclined converging surface portions 207, 208 of the forming wedge 209 can converge along the draw direction 154 to intersect along the root 145 of the forming vessel 140. A draw plane 213 of the glass manufacturing apparatus 100 can extend through the root 145 along the draw direction 154. In some embodiments, the ribbon 103 can be drawn in the draw direction 154 along the draw plane 213. As shown, the draw plane 213 can bisect the forming wedge 209 through the root 145 although, in some embodiments, the draw plane 213 can extend at other orientations relative to the root 145.

Additionally, in some embodiments, the molten material 121 can flow in a direction 156 into and along the trough 201 of the forming vessel 140. The molten material 121 can then overflow from the trough 201 by simultaneously flowing over corresponding weirs 203, 204 and downward over the outer surfaces 205, 206 of the corresponding weirs 203, 204. Respective streams of molten material 121 can then flow along the downwardly inclined converging surface portions 207, 208 of the forming wedge 209 to be drawn off the root 145 of the forming vessel 140, where the flows converge and fuse into the ribbon 103. The ribbon 103 of molten material can then be drawn off the root 145 in the draw plane 213 along the draw direction 154. In some embodiments, the ribbon 103 comprises one or more states of material based on a vertical location of the ribbon 103. For example, at one location, the ribbon 103 can comprise the viscous molten material 121, and at another location, the ribbon 103 can comprise an amorphous solid in a glassy state (e.g., a glass ribbon).

The ribbon 103 comprises a first major surface 215 and a second major surface 216 facing opposite directions and defining a thickness “T” (e.g., average thickness) of the ribbon 103. In some embodiments, the thickness “T′ of the ribbon 103 can be less than or equal to about 2 millimeters (mm), less than or equal to about 1 millimeter, less than or equal to about 0.5 millimeters, for example, less than or equal to about 300 micrometers (μm), less than or equal to about 200 micrometers, or less than or equal to about 100 micrometers, although other thicknesses may be provided in further embodiments. For example, in some embodiments, the thickness “T′ of the ribbon 103 can be within a range from about 20 μm to about 200 μm, within a range from about 50 μm to about 750 μm, within a range from about 100 μm to about 700 μm, within a range from about 200 μm to about 600 μm, within a range from about 300 μm to about 500 μm, within a range from about 50 μm to about 500 μm, within a range from about 50 μm to about 700 μm, within a range from about 50 μm to about 600 μm, within a range from about 25 μm to about 500 μm, within a range from about 50 μm to about 400 μm, within a range from about 50 μm to about 300 μm, within a range from about 50 μm to about 200 μm, within a range from about 50 μm to about 100 μm, within a range from about 25 μm to about 125 μm, comprising all ranges and subranges of thicknesses therebetween. In addition, the ribbon 103 can comprise a variety of composition, for example, soda-lime glass, borosilicate glass, alumino-borosilicate glass, alkali-containing glass, or alkali-free glass, alkali aluminosilicate glass, alkaline earth aluminosilicate glass, etc.

In some embodiments, the glass separator 149 (see FIG. 1) can then separate the glass ribbon 104 from the ribbon 103 along the separation path 151 as the ribbon 103 is formed by the forming vessel 140. As illustrated, in some embodiments, the separation path 151 can extend along the width “W” of the ribbon 103 between the first outer edge 153 and the second outer edge 155. Additionally, in some embodiments, the separation path 151 can extend perpendicular to the draw direction 154 of the ribbon 103. Moreover, in some embodiments, the draw direction 154 can define a direction along which the ribbon 103 can be drawn from the forming vessel 140.

In some embodiments, a plurality of separated glass ribbons 104 can be stacked to form a stack of separated glass ribbons 104. In some embodiments, interleaf material can be placed between an adjacent pair of separated glass ribbons 104 to help prevent contact and therefore preserve the pristine surfaces of the pair of separated glass ribbons 104.

In further embodiments, although not shown, the ribbon 103 from the glass manufacturing apparatus may be coiled onto a storage roll. Once a desired length of coiled ribbon is stored on the storage roll, the ribbon 103 may be separated by the glass separator 149 such that the separated glass ribbon is stored on the storage roll. In further embodiments, a separated glass ribbon can be separated into another separated glass ribbon. For example, a separated glass ribbon 104 (e.g., from the stack of glass ribbons) can be further separated into another separated glass ribbon. In further embodiments, a separated glass ribbon stored on a storage roll can be uncoiled and further separated into another separated glass ribbon.

The separated glass ribbon can then be processed into a desired application, e.g., a display application. For example, the separated glass ribbon can be used in a wide range of display applications, comprising liquid crystal displays (LCDs), electrophoretic displays (EPD), organic light emitting diode displays (OLEDs), plasma display panels (PDPs), touch sensors, photovoltaics, and other electronic displays.

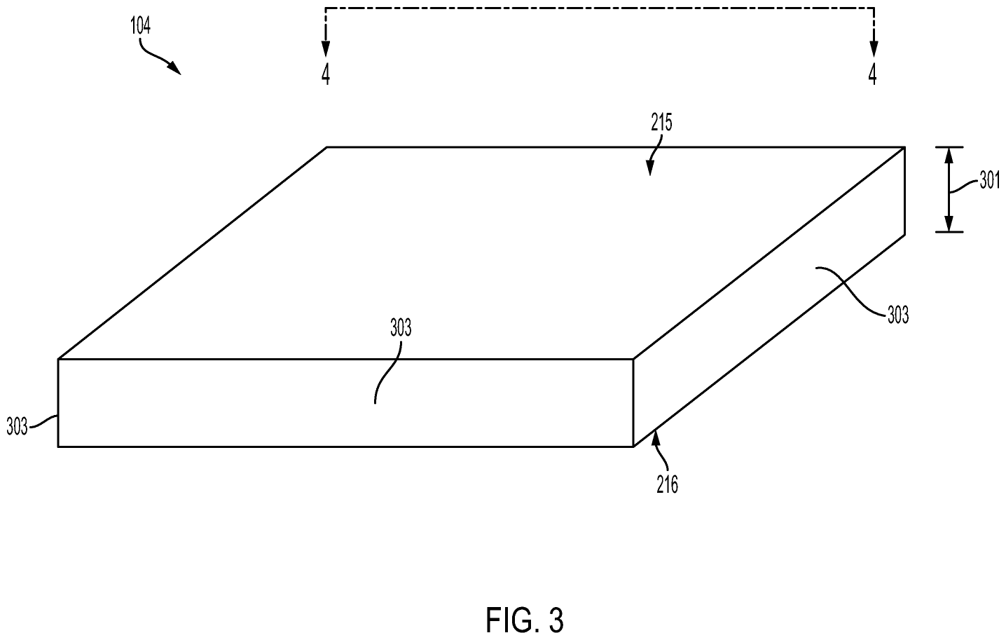

Referring to FIG. 3, a perspective view of the glass ribbon 104 is illustrated. The glass ribbon 104 can comprise the first major surface 215 and the second major surface 216. In some embodiments, one or more of the first major surface 215 or the second major surface 216 may be planar. For example, the first major surface 215 and the second major surface 216 may be planar, and, in some embodiments, the first major surface 215 may be parallel to the second major surface 216. An initial thickness 301 can be defined between the first major surface 215 and the second major surface 216 within a range from about 20 micrometers (μm) to about 200 μm or within a range from about 25 μm to about 125 μm. In some embodiments, the initial thickness 301 may be within a range from about 50 μm to about 100 μm. In some embodiments, the initial thickness 301 may be within a range from about 60 μm to about 80 μm. In some embodiments, the glass ribbon 104 can comprise an edge 303 extending between the first major surface 215 and the second major surface 216. The edge 303 can be defined at an outermost perimeter of the glass ribbon 104, and may extend about a border of the glass ribbon 104.

In some embodiments, the glass ribbon 104 can comprise one or more of an alkali-free aluminosilicate, borosilicate, boroaluminosilicate, or silicate glass composition. In some embodiments, the glass ribbon 104 can comprise alkali-containing aluminosilicate, borosilicate, boroaluminosilicate, or silicate glass compositions. In some embodiments, alkaline earth modifiers can be added to any of the foregoing compositions for the glass ribbon 104. In some embodiments, the glass ribbon 104 can comprise one or more of the following glass compositions: SiO₂ within a range from about 64% to about 69% (by mol %, all percentages of compositional elements being given in mol % unless stated otherwise), Al₂O₃ within a range from about 5% to about 12%, B₂O₃ within a range from about 8% to about 23%, MgO within a range from about 0.5% to about 2.5%, CaO within a range from about 1% to about 9%, SrO within a range from about 0% to about 5%, BaO within a range from about 0% to about 5%, SnO₂ within a range from about 0.1% to about 0.4%, ZrO₂ within a range from about 0% to about 0.1%, or Na₂O within a range from about 1% to about 1%. In some embodiments, the glass ribbon 104 can comprise one or more of the following glass compositions: SiO₂ at about 67.4% (by mol %), Al₂O₃ at about 12.7%, B₂O₃ at about 3.7%, MgO at about 2.4%, CaO at about 0%, SrO at about 0%, SnO₂ at about 0.1%, or Na₂O at about 13.7%. In some embodiments, the glass ribbon 104 can comprise a lower elastic modulus to reduce a tensile stress during bending.

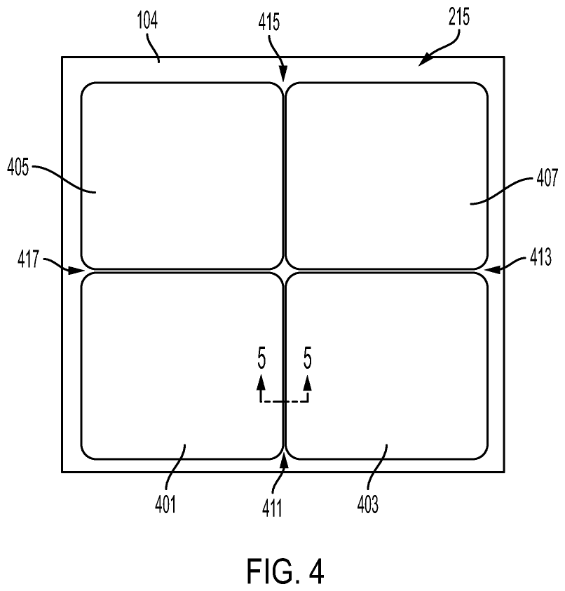

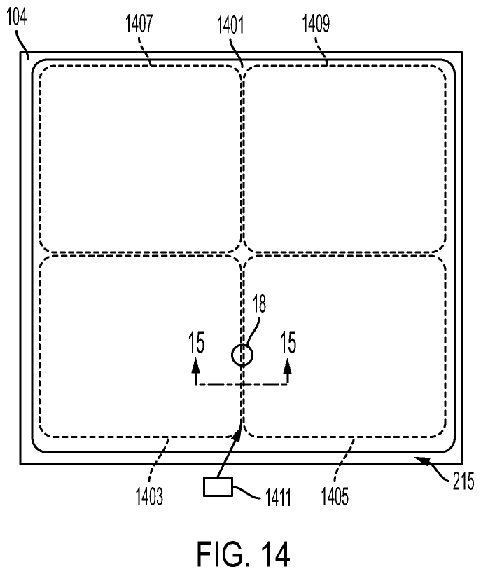

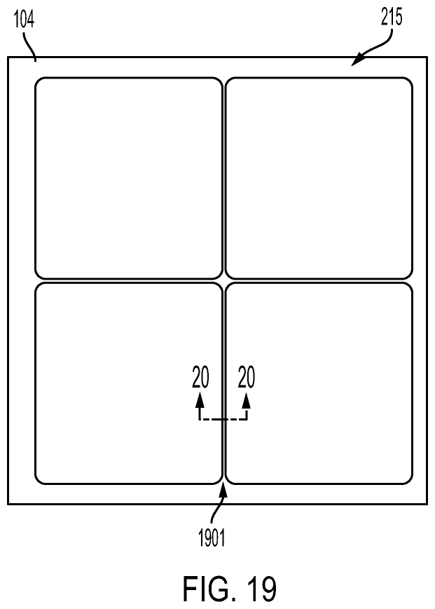

Referring to FIG. 4, a top view of the glass ribbon 104 is illustrated along line 4-4 of FIG. 3. In some embodiments, a portion of the glass ribbon 104 can be masked. For example, a first mask 401, a second mask 403, a third mask 405, and/or a fourth mask 407 can be positioned to cover the first major surface 215. In some embodiments, one or more unmasked areas may be defined between adjacent masks 401, 403, 405, 407. For example, a first unmasked area 411 may be defined between the first mask 401 and the second mask 403. A second unmasked area 413 may be defined between the second mask 403 and the fourth mask 407. A third unmasked area 415 may be defined between the third mask 405 and the fourth mask 407. A fourth unmasked area 417 may be defined between the first mask 401 and the third mask 405. In some embodiments, the unmasked areas 411, 413, 415, 417 may be exposed and not covered by a mask. For example, an axis perpendicular to the first major surface 215 may not intersect one of the masks 401, 403, 405, 407 at the first unmasked area 411, the second unmasked area 413, the third unmasked area 415, and/or the fourth unmasked area 417. While the glass ribbon 104 is illustrated as being masked by four masks in FIG. 4, the glass ribbon 104 is not so limited, and, in some embodiments, the glass ribbon 104 can be masked by zero or more masks. For example, in some embodiments, the glass ribbon 104 can be masked by the first mask 401 and the second mask 403, but not the third mask 405 or the fourth mask 407. In some embodiments, the glass ribbon 104 may initially be masked by a singled mask (e.g., as illustrated in FIG. 14), while in some embodiments, the glass ribbon 104 may initially be unmasked (e.g., as illustrated in FIG. 19).

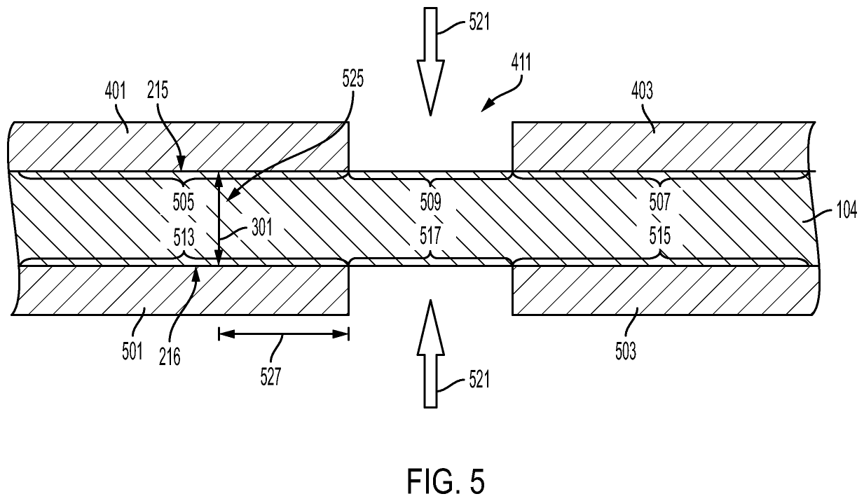

Referring to FIG. 5, a sectional view of the glass ribbon 104 is illustrated along line 5-5 of FIG. 4. In some embodiments, in addition to the first major surface 215 being at least partially masked (e.g., as illustrated in FIG. 4 with the first mask 401, the second mask 403, the third mask 405, and the fourth mask 407), the second major surface 216 can similarly be masked. In some embodiments, the second major surface 216 may be masked with the same number of masks of the first major surface 215. In some embodiments, one or all of the masks of the first major surface 215 may be paired with a corresponding mask of the second major surface 216. In some embodiments, the masks of each pair of masks may be laterally aligned along a direction perpendicular to the first major surface 215 and/or the second major surface 216. In some embodiments, the masks of each pair of masks may each be the same shape and/or size. For example, methods of manufacturing the glass ribbon 104 can comprise masking the first major surface 215 and the second major surface 216 of the glass ribbon 104 with one or more masks. In some embodiments, a fifth mask 501 can mask the second major surface 216 substantially opposite the first mask 401 masking the first major surface 215. In some embodiments, a shape, size, and lateral location of the first mask 401 can substantially match the fifth mask 501. For example, the first mask 401 and the fifth mask 501 may be laterally aligned wherein an axis substantially perpendicular to a plane defined by the glass ribbon 104 can, at some locations, intersect the first mask 401 and the fifth mask 501, and, at remaining locations, intersect none of the first mask 401 or the fifth mask 501. In some embodiments, a sixth mask 503 can mask the second major surface 216 substantially opposite the second mask 403 masking the first major surface 215. In some embodiments, a shape, size, and lateral location of the second mask 403 can substantially match the sixth mask 503. For example, the second mask 403 and the sixth mask 503 may be laterally aligned wherein an axis substantially perpendicular to a plane defined by the glass ribbon 104 can, at some locations, intersect the second mask 403 and the sixth mask 503, and, at remaining locations, intersect none of the second mask 403 or the sixth mask 503. Though not illustrated in FIG. 5, in some embodiments, additional masks can mask the second major surface 216 at locations that are substantially opposite the third mask 405 (e.g., illustrated in FIG. 4) and the fourth mask 407 (e.g., illustrated in FIG. 4) that mask the first major surface 215.

In some embodiments, methods of manufacturing the glass ribbon 104 can comprise masking a first region 505 and a second region 507 of the first major surface 215 of the glass ribbon 104. For example, to mask the first region 505 and the second region 507, the first mask 401 can be positioned to cover the first region 505 while the second mask 403 can be positioned to cover the second region 507. In some embodiments, the first mask 401 and the second mask 403 can be positioned to cover the corresponding region in several ways, for example, by lamination, screen printing, etc. In some embodiments, the first mask 401 and the second mask 403 can comprise a material that may be resistant to an etchant to which the glass ribbon 104 may be exposed. For example, the first mask 401 and/or the second mask 403 can comprise one or more of a Vitayon HF resistant ink or other etch resistant type inks, a photolithography resist (e.g., AZP4620, etc.), a polystyrene material with a silane modification, a laminated film, etc. By masking the first region 505 and the second region 507, a first exposed region 509 of the first major surface 215 may be exposed between the first region 505 and the second region 507, wherein the first exposed region 509 may not be covered by a mask. In some embodiments, methods of manufacturing the glass ribbon 104 can comprise masking a third region 513 and a fourth region 515 of the second major surface 216 of the glass ribbon 104. For example, to mask the third region 513 and the fourth region 515, the fifth mask 501 can be positioned to cover the third region 513 while the sixth mask 503 can be positioned to cover the fourth region 515. In some embodiments, the fifth mask 501 and the sixth mask 503 can be positioned to cover the corresponding region in several ways, for example, by lamination, screen printing, etc. In some embodiments, the fifth mask 501 and the sixth mask 503 can comprise a material that may be resistant to an etchant to which the glass ribbon 104 may be exposed. For example, the fifth mask 501 and/or the sixth mask 503 may comprise a similar material as the first mask 401 and the second mask 403, for example, by comprising one or more of a Vitayon HF resistant ink or other etch resistant type inks, a photolithography resist (e.g., AZP4620, etc.), a polystyrene material with a silane modification, a laminated film, etc. By masking the third region 513 and the fourth region 515, a second exposed region 517 of the second major surface 216 may be exposed between the third region 513 and the fourth region 515, wherein the second exposed region 517 may not be covered by a mask. In some embodiments, the masks illustrated and described herein relative to FIGS. 1-24 can comprise the same material, though, in some embodiments, the masks may comprise differing materials.

In some embodiments, methods of manufacturing the glass ribbon 104 can comprise etching the first exposed region 509 and the second exposed region 517 to separate a first ribbon portion, comprising the first region 505 and the third region 513, from a second ribbon portion, comprising the second region 507 and the fourth region 515. To etch the first exposed region 509 and the second exposed region 517, the glass ribbon 104 can be exposed to an etchant 521. For example, due to portions of the first major surface 215 and the second major surface 216 being masked (e.g., by the first mask 401, the second mask 403, the third mask 405, the fourth mask 407, the fifth mask 501, the sixth mask 503, etc.), the masked portions of the first major surface 215 and the second major surface 216 may be covered, sheltered, shielded, etc. In some embodiments, the masks 401, 403, 405, 407, 501, 503, can be resistant to the etchant 521 such that areas of the first major surface 215 and/or the second major surface 216 that may be covered by the masks 401, 403, 405, 407, 501, 503 may not be etched. In some embodiments, the masks 401, 403, 405, 407, 501, 503 can remain on the first major surface 215 or the second major surface 216 of the glass ribbon 104 during the etching. In some embodiments, the etchant 521 can comprise one or more of from about 0% to about 50% HF, a combination of HF and HNO₃, HₛSO₄, etc.

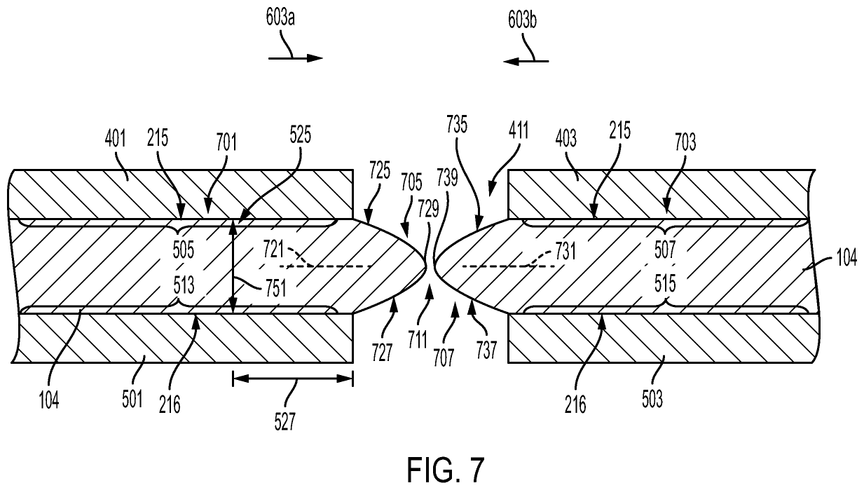

In some embodiments, methods of manufacturing the glass ribbon 104 can comprise maintaining the initial thickness 301 of the glass ribbon 104 such that the initial thickness 301 of the glass ribbon 104, defined between the first major surface 215 and the second major surface 216 at a first location 525 spaced a distance 527 apart from the first exposed region 509 and the second exposed region 517, prior to etching may be substantially equal to a final thickness (e.g., final thickness 751 illustrated in FIG. 7) of a first ribbon portion (e.g., first ribbon portion 701 illustrated in FIG. 7), defined between the first major surface 215 and the second major surface 216 at the first location 525, after etching. For example, due to the masking of portions of the first major surface 215 and the second major surface 216, the masked portions (e.g., the first region 505, the second region 507, the third region 513, the fourth region 515) may not be exposed to the etchant 521, such that the initial thickness 301 of the masked portions of the glass ribbon 104 can be maintained. In some embodiments, the initial thickness 301 can be maintained throughout the etching, for example, from the time that the glass ribbon 104 is initially exposed to the etchant 521 to the time that exposure of the glass ribbon 104 to the etchant 521 has concluded. In some embodiments, after the exposure of the glass ribbon 104 to the etchant 521 has concluded (e.g., illustrated in FIG. 7), the final thickness 751 of the masked portions of the glass ribbon 104 may be substantially equal to the initial thickness 301 of the masked portions of the glass ribbon 104. In some embodiments, the maintaining the initial thickness 301 of the glass ribbon 104 can comprise maintain the initial thickness 301 that may be within a range from about 20 μm to about 200 μm or within a range from about 25 μm to about 125 μm. For example, the initial thickness 301, may be within a range from about 20 μm to about 200 μm or within a range from about 25 μm to about 125 μm, can be maintained such that the final thickness 751 may likewise be within a range from about 20 μm to about 200 μm or within a range from about 25 μm to about 125 μm.

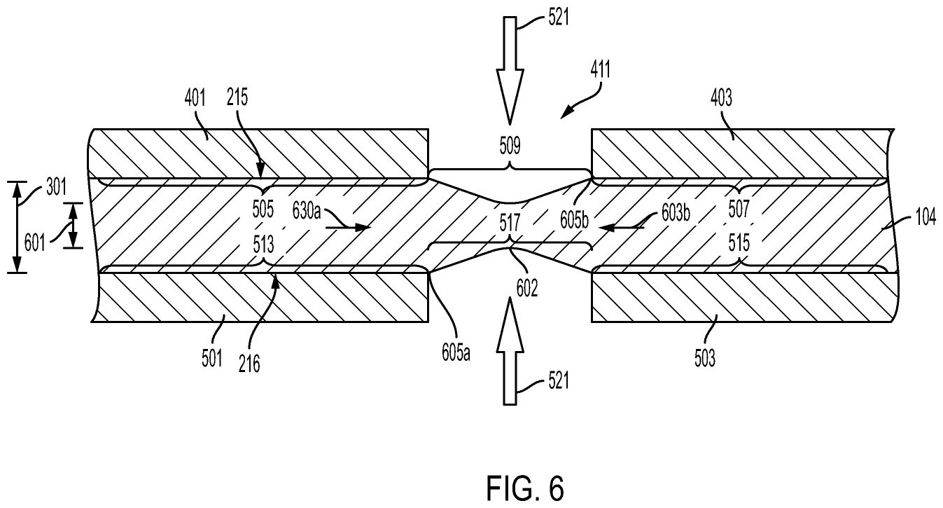

Referring to FIG. 6, the glass ribbon 104 is illustrated during the etching while the first unmasked area 411 (e.g., comprising the first exposed region 509 and the second exposed region 517) is exposed to the etchant 521. In some embodiments, the etchant 521 can reduce a thickness of the glass ribbon 104 at the first unmasked area 411. For example, after exposing the first exposed region 509 and the second exposed region 517 to the etchant 521 for a period of time, a minimum thickness 601 of the glass ribbon 104 between the first exposed region 509 and the second exposed region 517 may be less than the initial thickness 301 of the glass ribbon 104 at areas that may be masked (e.g., between the first region 505 and the third region 513, between the second region 507 and the fourth region 515, etc.). In some embodiments, the minimum thickness 601 of the glass ribbon 104 may be located at an intermediate location 602 (e.g., midpoint) between the first mask 401 and the second mask 403, and between the fifth mask 501 and the sixth mask 503. For example, the glass ribbon 104 at the first unmasked area 411 may comprise an hour-glass shape, wherein the thickness of the glass ribbon 104 tapers in a first direction 603a that extends away from a location 605a adjacent the first region 505 and the third region 513 to the intermediate location 602 and wherein the thickness of the glass ribbon 104 tapers in a second direction 603b, opposite the first direction 603a, that extends away from a location 605b adjacent the second region 507 and the fourth region 515 to the intermediate location 602.

Referring to FIG. 7, in some embodiments, methods of manufacturing the glass ribbon 104 can comprise etching the first exposed region 509 and the second exposed region 517 (e.g., illustrated in FIGS. 5-6) to separate a first ribbon portion 701, comprising the first region 505 and the third region 513, from a second ribbon portion 703, comprising the second region 507 and the fourth region 515, and form a first tapered edge 705 at the first ribbon portion 701 and a second tapered edge 707 at the second ribbon portion 703. For example, the first exposed region 509 and the second exposed region 517 can be exposed to the etchant 521 such that the etching (e.g., illustrated in FIGS. 5-6) can continue until a gap 711 is formed in the first unmasked area 411. When the gap 711 is formed, the first ribbon portion 701 (e.g., comprising the first region 505 and the third region 513 of the glass ribbon 104) may be separated from the second ribbon portion 703 (e.g., comprising the second region 507 and the fourth region 515). Once the gap 711 is formed, the etching may stop. In some embodiments, the etching the first exposed region 509 and the second exposed region 517 can comprise exposing the first exposed region 509 and the second exposed region 517 to the etchant 521 for a period of time until the first ribbon portion 701 is separated from the second ribbon portion 703, and the gap 711 is formed between the first tapered edge 705 of the first ribbon portion 701 and the second tapered edge 707 of the second ribbon portion 703. In some embodiments, the etching the glass ribbon 104 can comprise exposing the first major surface 215 and the second major surface 216 to the etchant 521 for a period of time until the first ribbon portion 701 is separated from the second ribbon portion 703 and the gap 711 is formed between the first tapered edge 705 of the first ribbon portion 701 and the second tapered edge 707 of the second ribbon portion 703.

In some embodiments, the first tapered edge 705 can comprise a thickness that may be non-constant. For example, the first tapered edge 705 can comprise a thickness that decreases along a first axis 721, which may be parallel to the first major surface 215 and the second major surface 216 of the first ribbon portion 701, in the first direction 603a from a center of the first ribbon portion 701 towards a perimeter of the first ribbon portion 701. For example, the first tapered edge 705 can comprise a first intermediate surface 725 and a second intermediate surface 727. The first intermediate surface 725 may be contiguous with the first major surface 215 of the first ribbon portion 701, while the second intermediate surface 727 may be contiguous with the second major surface 216 of the first ribbon portion 701. In some embodiments, the first intermediate surface 725 may not be co-planar with the first major surface 215 of the first ribbon portion 701, and may be non-parallel with the first major surface 215 of the first ribbon portion 701. In some embodiments, the second intermediate surface 727 may not be co-planar with the second major surface 216 of the first ribbon portion 701, and may be non-parallel with the second major surface 216 of the first ribbon portion 701. In some embodiments, the first intermediate surface 725 and the second intermediate surface 727 may be non-parallel, for example, with the first intermediate surface 725 and the second intermediate surface 727 converging along the first axis 721 in the first direction 603a. In some embodiments, the first intermediate surface 725 and the second intermediate surface 727 can converge to a point at a first outer boundary 729 of the first tapered edge 705. In some embodiments, the first outer boundary 729 can comprise a rounded shape.

In some embodiments, the second tapered edge 707 can comprise a thickness that may be non-constant. For example, the second tapered edge 707 can comprise a thickness that decreases along a second axis 731, which may be parallel to the first major surface 215 and the second major surface 216 of the second ribbon portion 703, in the second direction 603b from a center of the second ribbon portion 703 towards a perimeter of the second ribbon portion 703. For example, the second tapered edge 707 can comprise a third intermediate surface 735 and a fourth intermediate surface 737. The third intermediate surface 735 may be contiguous with the first major surface 215 of the second ribbon portion 703, while the fourth intermediate surface 737 may be contiguous with the second major surface 216 of the second ribbon portion 703. In some embodiments, the third intermediate surface 735 may not be co-planar with the first major surface 215 of the second ribbon portion 703, and may be non-parallel with the first major surface 215 of the second ribbon portion 703. In some embodiments, the fourth intermediate surface 737 may not be co-planar with the second major surface 216 of the second ribbon portion 703, and may be non-parallel with the second major surface 216 of the second ribbon portion 703. In some embodiments, the third intermediate surface 735 and the fourth intermediate surface 737 may be non-parallel, for example, with the third intermediate surface 735 and the fourth intermediate surface 737 converging along the second axis 731 in the second direction 603b. In some embodiments, the third intermediate surface 735 and the fourth intermediate surface 737 can converge to a point at a second outer boundary 739 of the second tapered edge 707. In some embodiments, the second outer boundary 739 can comprise a rounded shape.

Following the separation of the first ribbon portion 701 and the second ribbon portion 703, the first ribbon portion 701 and the second ribbon portion 703 can be unmasked. For example, the first mask 401 and the fifth mask 501 can be removed from the first ribbon portion 701, while the second mask 403 and the sixth mask 503 can be removed from the second ribbon portion 703. The first ribbon portion 701 and the second ribbon portion 703 can be unmasked in several ways, for example, by rinsing the mask from the first major surface 215 and/or the second major surface 216. In some embodiments, a liquid can be directed towards the mask 401, 501, 403, 503 to remove the mask 401, 501, 403, 503 from the first major surface 215 and/or the second major surface 216. In some embodiments, a pressurized liquid can be directed at a sufficient velocity to remove the mask 401, 501, 403, 503 and unmask the first ribbon portion 701 and the second ribbon portion 703. Following the unmasking, in some embodiments, the first ribbon portion 701 and the second ribbon portion 703 can be submerged within a strengthening bath to generate compressive stress regions along one or more surfaces of the first ribbon portion 701 or the second ribbon portion 703.

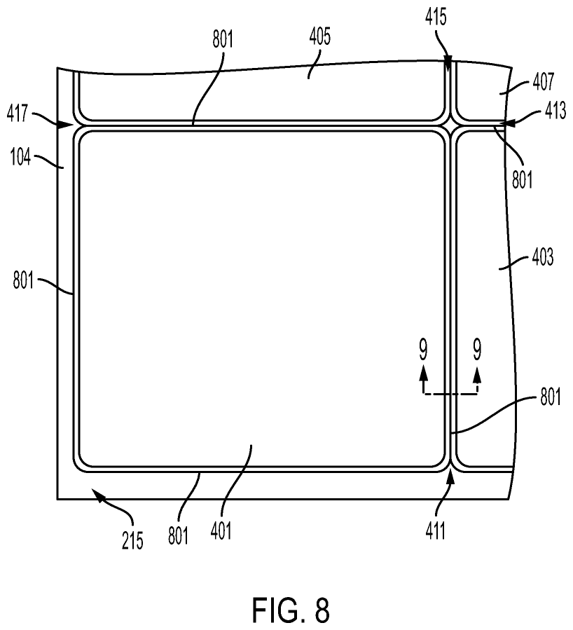

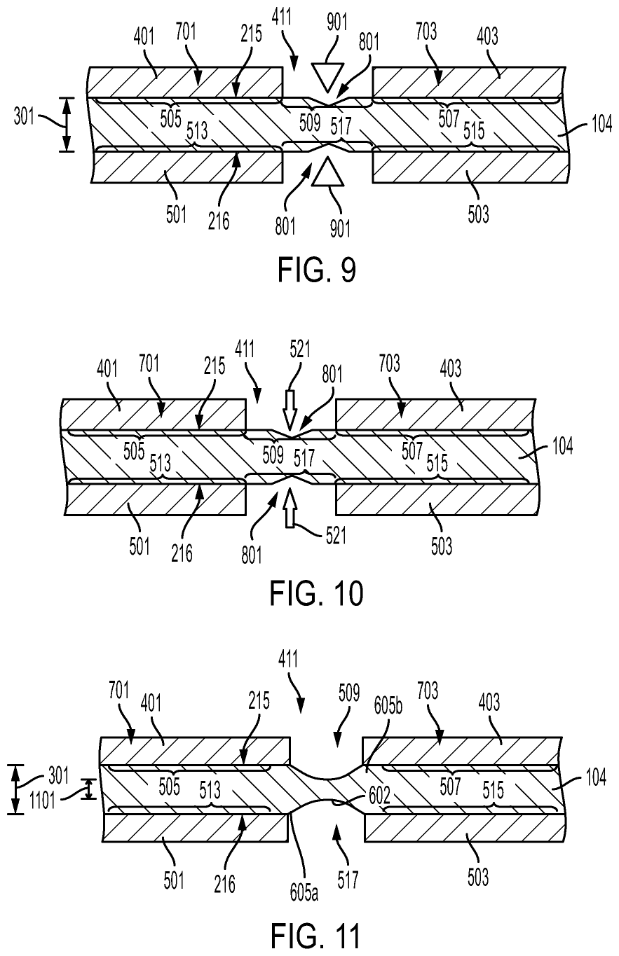

Referring to FIG. 8, further embodiments of methods of manufacturing the glass ribbon 104 are illustrated. In some embodiments, an initial groove 801 can be formed in the glass ribbon 104 between the first mask 401, the second mask 403, the third mask 405, and the fourth mask 407. For example, the initial groove 801 can be formed in the first unmasked area 411, the second unmasked area 413, the third unmasked area 415, and the fourth unmasked area 417. For example, referring to FIG. 9, a sectional view of the glass ribbon 104 is illustrated along line 9-9 of FIG. 8. In some embodiments, methods of manufacturing the glass ribbon 104 can comprise forming, prior to etching, the initial groove 801 at the first exposed region 509. In some embodiments, methods of manufacturing the glass ribbon 104 can comprise forming the initial groove 801 at one or more of the first major surface 215 of the glass ribbon or the second major surface 216 of the glass ribbon 104, wherein the initial groove 801 may be formed between the first ribbon portion 701 of the glass ribbon 104 and the second ribbon portion 703 of the glass ribbon 104. For example, as illustrated in FIG. 9, in some embodiments, the initial groove 801 can be formed in the first major surface 215 and the second major surface 216. In some embodiments, the initial groove 801 can be formed in the first major surface 215 and not the second major surface 216, though, in some embodiments, the initial groove 801 can be formed in the second major surface 216 and not the first major surface 215. The initial groove 801 can be formed in several ways. For example, in some embodiments, the forming the initial groove 801 can comprise scoring the first exposed region 509 to reduce an etch time of the first exposed region 509 and the second exposed region 517. In some embodiments, a scoring device 901 can score the first exposed region 509 to form the initial groove 801. The scoring device 901 can comprise, for example, a laser (e.g., a CO₂ laser, a CO laser, a Bessel beam laser, a CLT laser, etc.), a scoring wheel, steel wool or sand sponge abrasion, etc. In addition or in the alternative, in some embodiments, the forming the initial groove 801 can comprise scoring the second exposed region 517 to reduce an etch time of the first exposed region 509 and the second exposed region 517. In some embodiments, an additional scoring device 901 can score the second exposed region 517 to form the initial groove 801.

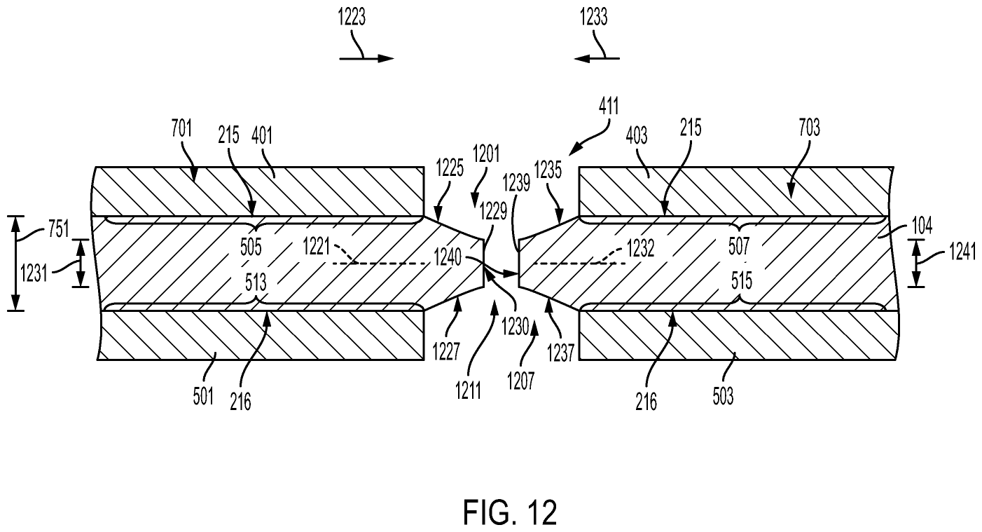

Referring to FIG. 10, in some embodiments, methods of manufacturing the glass ribbon 104 can comprise etching the first exposed region 509 and the second exposed region 517 to separate the first ribbon portion 701, comprising the first region 505 and the third region 513, from the second ribbon portion 703, comprising the second region 507 and the fourth region 515 along the initial groove 801 and form a first tapered edge (e.g., illustrated in FIG. 12) at the first ribbon portion 701 and a second tapered edge (e.g., illustrated in FIG. 12) at the second ribbon portion 703. By etching the first exposed region 509 and the second exposed region 517, the glass ribbon 104 can be exposed to the etchant 521. For example, due to portions of the first major surface 215 and the second major surface 216 being masked (e.g., by the first mask 401, the second mask 403, the third mask 405, the fourth mask 407, the fifth mask 501, the sixth mask 503, etc.), the masked portions of the first major surface 215 and the second major surface 216 may be covered, sheltered, shielded, etc. In some embodiments, the masks 401, 403, 405, 407, 501, 503, can be resistant to etching such that areas of the first major surface 215 or the second major surface 216 that may be covered by the masks 401, 403, 405, 407, 501, 503 may not be etched. In some embodiments, the masks 401, 403, 405, 407, 501, 503 may be impervious to the etchant, such that when the glass ribbon 104 and the masks 401, 403, 405, 407, 501, 503 may be exposed to the etchant 521, the masks 401, 403, 405, 407, 501, 503 can remain on the first major surface 215 or the second major surface 216 of the glass ribbon 104. In some embodiments, the etchant 521 can comprise one or more of from about 0% to about 50% HF, a combination of HF and HNO₃, HₛSO₄, etc.

Referring to FIG. 11, in some embodiments, the etchant 521 can reduce a thickness of the glass ribbon 104 at the first unmasked area 411. For example, after exposing the first exposed region 509 and the second exposed region 517 to the etchant 521 for a period of time, a minimum thickness 1101 of the glass ribbon 104 between the first exposed region 509 and the second exposed region 517 may be reduced and may be less than the initial thickness 301 of the glass ribbon 104 at areas that may be masked (e.g., between the first region 505 and the third region 513, between the second region 507 and the fourth region 515, etc.). In some embodiments, the minimum thickness 1101 of the glass ribbon 104 may be located at the intermediate location 602 (e.g., midpoint) between the first mask 401 and the second mask 403, and between the fifth mask 501 and the sixth mask 503. In some embodiments, the etching the first exposed region 509 and the second exposed region 517 can comprise exposing the first exposed region 509 and the second exposed region 517 to the etchant 521 and concluding an exposure of the first exposed region 509 and the second exposed region 517 to the etchant 521 prior to the first ribbon portion 701 separating from the second ribbon portion 703. For example, as illustrated in FIG. 10, the first exposed region 509 and the second exposed region 517 may be exposed to the etchant 521, while in FIG. 11, exposure of the first exposed region 509 and the second exposed region 517 to the etchant 521 may be concluded while the first ribbon portion 701 is still attached to the second ribbon portion 703 (e.g., prior to the first ribbon portion 701 separating from the second ribbon portion 703). For example, as illustrated in FIG. 11, the minimum thickness 1101 of the first unmasked area 411 may be less than the initial thickness 301 of the glass ribbon 104 at areas that may be masked, though, the first unmasked area 411 may no longer be exposed to the etchant 521. In some embodiments, the formation of the initial groove 801 can reduce an etch time of the glass ribbon 104.

Referring to FIG. 12, in some embodiments, separating the first exposed region 509 and the second exposed region 517 can comprise applying a mechanical force to the glass ribbon 104 to separate the first ribbon portion 701 from the second ribbon portion 703 after concluding the exposure of the first exposed region 509 and the second exposed region 517 to the etchant 521. For example, the mechanical force can be applied using an ultrasonic vibration, or other types of vibration, for example, uneven rolls, thermal shock, air bursts, etc. Due to the minimum thickness 1101 (e.g., illustrated in FIG. 11) of the first unmasked area 411 of the glass ribbon 104 being less than the initial thickness 301 of the glass ribbon 104 at the masked areas, the mechanical force can cause the glass ribbon 104 to break at the first unmasked area 411, wherein a crack can propagate through the first unmasked area 411 between the first exposed region 509 and the second exposed region 517. In some embodiments, the mechanical force can be great enough to cause the glass ribbon 104 to break at the first unmasked area 411, but small enough to not cause the glass ribbon 104 to break at other locations, for example, the areas of the glass ribbon 104 that may be masked and comprise the initial thickness 301. In some embodiments, the mechanical force can be applied during the etching, for example, when the mechanical force is applied by ultrasonic waves, or other methods different from applying a bending moment.

In some embodiments, the etching of the first exposed region 509 and the second exposed region 517 followed by the application of the mechanical force to the glass ribbon 104 to separate the first ribbon portion 701, comprising the first region 505 and the third region 513, from the second ribbon portion 703, comprising the second region 507 and the fourth region 515, can form a first tapered edge 1201 at the first ribbon portion 701 and a second tapered edge 1207 at the second ribbon portion 703. For example, following the application of the mechanical force to the glass ribbon 104 and the separation of the first ribbon portion 701 from the second ribbon portion 703, a gap 1211 can be formed in the first unmasked area 411. When the gap 1211 is formed, the first ribbon portion 701 (e.g., comprising the first region 505 and the third region 513 of the glass ribbon 104) can be separated from the second ribbon portion 703 (e.g., comprising the second region 507 and the fourth region 515).

In some embodiments, the first tapered edge 1201 can comprise a thickness that may be non-constant. For example, the first tapered edge 1201 can comprise a thickness that decreases along a first axis 1221, which may be parallel to the first major surface 215 and the second major surface 216 of the first ribbon portion 701, in a first direction 1223 from a center of the first ribbon portion 701 towards a perimeter of the first ribbon portion 701. For example, the first tapered edge 1201 can comprise a first intermediate surface 1225 and a second intermediate surface 1227. The first intermediate surface 1225 may be contiguous with the first major surface 215 of the first ribbon portion 701, while the second intermediate surface 1227 may be contiguous with the second major surface 216 of the first ribbon portion 701. In some embodiments, the first intermediate surface 1225 may not be co-planar with the first major surface 215 of the first ribbon portion 701, and may be non-parallel with the first major surface 215 of the first ribbon portion 701. In some embodiments, the second intermediate surface 1227 may not be co-planar with the second major surface 216 of the first ribbon portion 701, and may be non-parallel with the second major surface 216 of the first ribbon portion 701. In some embodiments, the first intermediate surface 1225 and the second intermediate surface 1227 may be non-parallel, for example, with the first intermediate surface 1225 and the second intermediate surface 1227 converging along the first axis 1221 in the first direction 1223.

In some embodiments, the first intermediate surface 1225 and the second intermediate surface 1227 can converge at a first outer boundary 1229 of the first tapered edge 1201. For example, the first outer boundary 1229 can comprise a first edge surface 1230 that comprises a substantially planar shape. In some embodiments, the first intermediate surface 1225 and the second intermediate surface 1227 can converge towards the first edge surface 1230, with the first edge surface 1230 extending between the first intermediate surface 1225 and the second intermediate surface 1227. In some embodiments, the first edge surface 1230 may extend along a first plane that may be substantially perpendicular to one or more of the first axis 1221, the first major surface 215, or the second major surface 216 of the first ribbon portion 701. In some embodiments, the first edge surface 1230 can comprise a first boundary thickness 1231 between the first intermediate surface 1225 and the second intermediate surface 1227, with the first boundary thickness 1231 being substantially equal to the minimum thickness 1101 (e.g., illustrated in FIG. 11) of the first unmasked area 411 when the etching is concluded. In some embodiments, the first tapered edge 1201 can comprise a truncated shape, wherein the first intermediate surface 1225 and the second intermediate surface 1227 do not converge to a point, but, rather, the first intermediate surface 1225 and the second intermediate surface 1227 converge to the first edge surface 1230 that separates the first intermediate surface 1225 and the second intermediate surface 1227.

In some embodiments, the second tapered edge 1207 can comprise a size, shape, and dimension that substantially matches the first tapered edge 1201. For example, the second tapered edge 1207 can comprise a thickness that may be non-constant. In some embodiments, the second tapered edge 1207 can comprise a thickness that decreases along a second axis 1232, which may be parallel to the first major surface 215 and the second major surface 216 of the second ribbon portion 703, in a second direction 1233 from a center of the second ribbon portion 703 towards a perimeter of the second ribbon portion 703. For example, the second tapered edge 1207 can comprise a third intermediate surface 1235 and a fourth intermediate surface 1237. The third intermediate surface 1235 may be contiguous with the first major surface 215 of the second ribbon portion 703, while the fourth intermediate surface 1237 may be contiguous with the second major surface 216 of the second ribbon portion 703. In some embodiments, the third intermediate surface 1235 may not be co-planar with the first major surface 215 of the second ribbon portion 703, and may be non-parallel with the first major surface 215 of the second ribbon portion 703. In some embodiments, the fourth intermediate surface 1237 may not be co-planar with the second major surface 216 of the second ribbon portion 703, and may be non-parallel with the second major surface 216 of the second ribbon portion 703. In some embodiments, the third intermediate surface 1235 and the fourth intermediate surface 1237 may be non-parallel, for example, with the third intermediate surface 1235 and the fourth intermediate surface 1237 converging along the second axis 1232 in the second direction 1233.

In some embodiments, the third intermediate surface 1235 and the fourth intermediate surface 1237 can converge at a second outer boundary 1239 of the second tapered edge 1207. For example, the second outer boundary 1239 can comprise a second edge surface 1240 that comprises a substantially planar shape. In some embodiments, the third intermediate surface 1235 and the fourth intermediate surface 1237 can converge towards the second edge surface 1240, with the second edge surface 1240 extending between the third intermediate surface 1235 and the fourth intermediate surface 1237. In some embodiments, the second edge surface 1240 may extend along a second plane that may be substantially perpendicular to one or more of the second axis 1232, the first major surface 215, or the second major surface 216 of the second ribbon portion 703. In some embodiments, the second edge surface 1240 can comprise a second boundary thickness 1241 between the third intermediate surface 1235 and the fourth intermediate surface 1237, with the second boundary thickness 1241 being substantially the same as one or more of the minimum thickness 1101 (e.g., illustrated in FIG. 11) of the first unmasked area 411 when the etching is concluded or the first boundary thickness 1231. In some embodiments, the second tapered edge 1207 can comprise a truncated shape, wherein the third intermediate surface 1235 and the fourth intermediate surface 1237 do not converge to a point, but, rather, the third intermediate surface 1235 and the fourth intermediate surface 1237 converge to the second edge surface 1240 that separates the third intermediate surface 1235 and the fourth intermediate surface 1237.

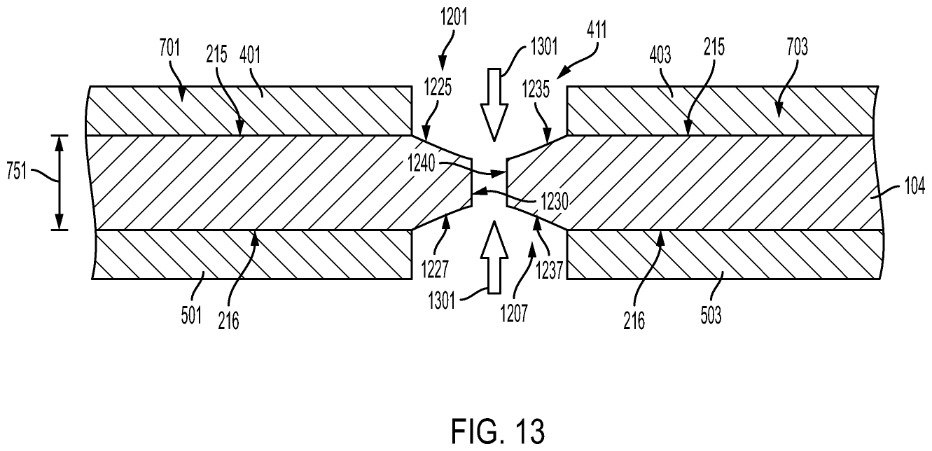

Referring to FIG. 13, in some embodiments, the first intermediate surface 1225 and the second intermediate surface 1227 can be cleaned and/or etched after the first ribbon portion 701 has been separated from the second ribbon portion 703. For example, with the first mask 401, the second mask 403, the fifth mask 501, and the sixth mask 503 covering the first major surface 215 and the second major surface 216 of the first ribbon portion 701 and the second ribbon portion 703, the cleaning can comprise a final etching of the first tapered edge 1201 and the second tapered edge 1207. For example, the first tapered edge 1201 and the second tapered edge 1207 can be exposed to a second etchant 1301. In some embodiments, etching the first exposed region 509 (e.g., illustrated in FIGS. 9-11) and the second exposed region 517 (e.g., illustrated in FIGS. 9-11) comprises, following the separation of the first ribbon portion 701 from the second ribbon portion 703, exposing the first tapered edge 1201 and the second tapered edge 1207 to the second etchant 1301. In some embodiments, the second etchant 1301 can be similar to the etchant 521, and may comprise one or more of from about 0% to about 50% HF, a combination of HF and HNO₃, HₛSO₄, etc., though, in some embodiments, the second etchant 1301 can comprise a different material than the etchant 521. By controlling etching time and/or the material of the second etchant 1301, defects on surfaces 1225, 1227, 1230 of the first ribbon portion 701 and/or on surfaces 1235, 1237, 1240 of the second ribbon portion 703 can be removed.

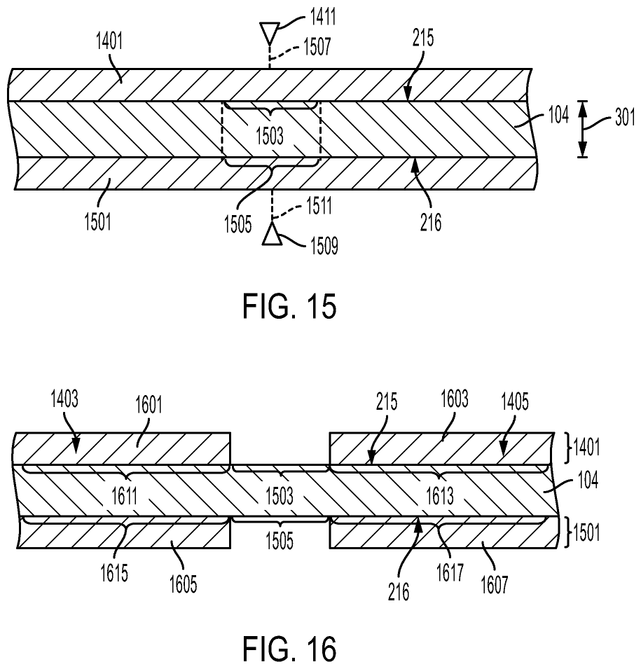

Referring to FIG. 14, further embodiments of methods of manufacturing the glass ribbon 104 are illustrated. FIG. 14 illustrates a top view of the glass ribbon 104 in which a portion of the glass ribbon 104 is masked. For example, a first mask 1401 can be positioned to cover the first major surface 215 of the glass ribbon 104. In some embodiments, unmasked areas may exist along edges of the glass ribbon 104, though, a central portion of the glass ribbon 104 may be covered by the first mask 1401. In some embodiments, the glass ribbon 104 can comprise one or more ribbon portions, for example, a first ribbon portion 1403, a second ribbon portion 1405, a third ribbon portion 1407, and a fourth ribbon portion 1409. The first ribbon portion 1403, the second ribbon portion 1405, the third ribbon portion 1407, and the fourth ribbon portion 1409 are illustrated with dashed lines in FIG. 14, as the first ribbon portion 1403, the second ribbon portion 1405, the third ribbon portion 1407, and the fourth ribbon portion 1409 may initially be unseparated and covered by the first mask 1401. The dashed lines can represent a location of the first ribbon portion 1403, the second ribbon portion 1405, the third ribbon portion 1407, and the fourth ribbon portion 1409 following etching and separation (e.g., illustrated in FIGS. 15-16). In some embodiments, a portion of the first mask 1401 can be removed to expose the first major surface 215. The first mask 1401 can be removed in several ways, for example, by a first laser 1411 that can laser cut the first mask 1401 and remove a portion of the first mask 1401. In some embodiments, the first laser 1411 can comprise a CO₂ laser, a CO laser, a Bessel beam laser, etc. The first laser 1411 can move relative to the glass ribbon 104, which may remain stationary, though, in some embodiments, the glass ribbon 104 can move relative to the first laser 1411, with the first laser 1411 remaining stationary.

Referring to FIG. 15, a sectional view of the glass ribbon 104 is illustrated along line 15-15 of FIG. 14. In some embodiments, methods of manufacturing the glass ribbon 104 can comprise initially masking the first major surface 215 and the second major surface 216 of the glass ribbon 104. For example, the first mask can be positioned to cover the first major surface 215 while a second mask 1501 can be positioned to cover the second major surface 216 of the glass ribbon 104. In some embodiments, the first mask 1401 and the second mask 1501 can be positioned to cover the corresponding region in several ways, for example, by lamination, screen printing, etc. In some embodiments, the first mask 1401 and the second mask 1501 can comprise a material that may be resistant to an etchant to which the glass ribbon 104 may be exposed. For example, the first mask 1401 and/or the second mask 1501 can comprise one or more of a Vitayon HF resistant ink or other etch resistant type inks, a photolithography resist (e.g., AZP4620, etc.), a polystyrene material with a silane modification, a laminated film, etc.

In some embodiments, methods of manufacturing the glass ribbon 104 can comprise unmasking a first exposed region 1503 of the first major surface 215 and a second exposed region 1505 of the second major surface 216. In some embodiments, the unmasking the first exposed region 1503 and the second exposed region 1505 can comprise directing a laser beam towards the first mask 1401 covering the first exposed region 1503 and a second mask 1501 covering the second exposed region 1505. For example, the first laser 1411 can direct a first laser beam 1507 towards the portion of the first mask 1401 that covers the first exposed region 1503 of the first major surface 215. In some embodiments, the first laser beam 1507 can ablate and remove the portion of the first mask 1401 that covers the first exposed region 1503. In some embodiments, a second laser 1509 can be provided for unmasking the second exposed region 1505. The second laser 1509 can be similar to the first laser 1411, and may comprise a CO₂ laser, a CO laser, a Bessel beam laser, etc. In some embodiments, the second laser 1509 can direct a second laser beam 1511 towards the portion of the second mask 1501 that covers the second exposed region 1505 of the second major surface 216. In some embodiments, the second laser beam 1511 can ablate and remove the portion of the second mask 1501 that covers the second exposed region 1505.

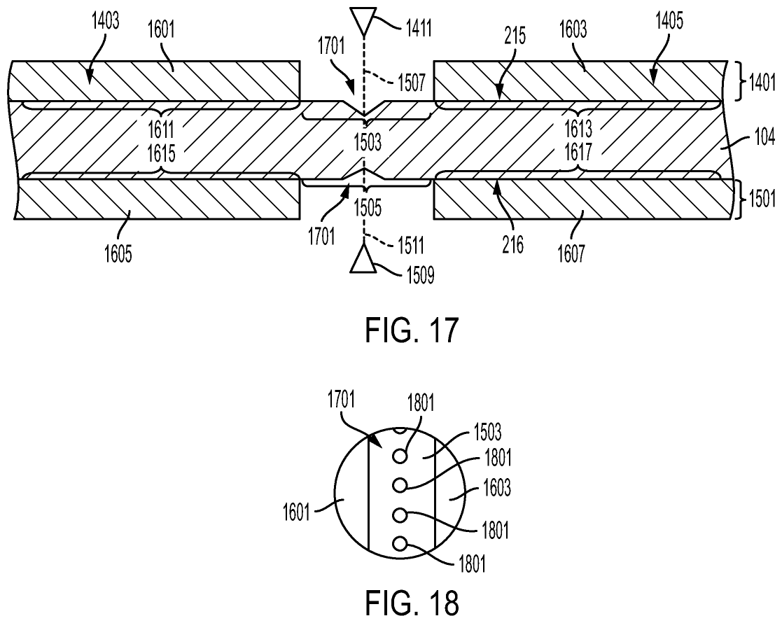

Referring to FIG. 16, following the unmasking of the first exposed region 1503 and the second exposed region 1505, the first mask 1401 may cover a portion of the first major surface 215 while the second mask 1501 may cover a portion of the second major surface 216. For example, the first mask 1401 can comprise a first mask portion 1601 and a second mask portion 1603, while the second mask 1501 can comprise a third mask portion 1605 and a fourth mask portion 1607. The first mask portion 1601 can cover a first region 1611 of the first major surface 215, while the second mask portion 1603 can cover a second region 1613 of the first major surface 215. The first exposed region 1503 can lie between the first region 1611 and the second region 1613. In some embodiments, the third mask portion 1605 can cover a third region 1615 of the second major surface 216, while the fourth mask portion 1607 can cover a fourth region 1617 of the second major surface 216. The second exposed region 1505 can lie between the third region 1615 and the fourth region 1617. In some embodiments, an initial groove (e.g., illustrated in FIG. 17) may not be formed in the first exposed region 1503 and the second exposed region 1505. Rather, the first exposed region 1503 and the second exposed region 1505 can be exposed to the etchant 521 (e.g., illustrated in FIG. 5) in a similar manner as illustrated and described relative to FIGS. 5-7. For example, the etchant 521 can etch the first exposed region 1503 and the second exposed region 1505 to separate the first ribbon portion 1403 from the second ribbon portion 1405. In addition, the etching of the first exposed region 1503 and the second exposed region 1505 can form the first tapered edge 705 at the first ribbon portion 1403 and the second tapered edge 707 at the second ribbon portion 1405.

Referring to FIG. 17, in some embodiments, following the unmasking of the first exposed region 1503 and the second exposed region 1505 (e.g., illustrated in FIG. 15), methods of manufacturing the glass ribbon 104 can comprise forming an initial groove 1701 at one or more of the first exposed region 1503 or the second exposed region 1505, the initial groove 1701 formed between the first ribbon portion 1403 of the glass ribbon 104 and the second ribbon portion 1405 of the glass ribbon 104. In some embodiments, the initial groove 1701 may be similar to the initial groove 801 illustrated in FIG. 10. For example, the initial groove 1701 can be formed in both the first exposed region 1503 and the second exposed region 1505, with the initial groove 1701 comprising a channel, a trench, an opening, etc. The initial groove 1701 can be formed in several ways. In some embodiments, the forming the initial groove 1701 can comprise directing the first laser beam 1507 (e.g., illustrated in FIG. 17) towards the first exposed region 1503 to form the initial groove 1701 in the first exposed region 1503, and directing the second laser beam 1511 (e.g., illustrated in FIG. 17) towards the second exposed region 1505 to form the initial groove 1701 in the second exposed region 1505. In some embodiments, the initial groove 1701 may be formed simultaneously with the removal of the mask portions. The initial groove 1701 may not be limited to being formed by a laser, and in some embodiments, the forming the initial groove 1701 can comprise scoring the first exposed region 1503 to reduce an etch time of the first exposed region 1503 and the second exposed region 1505. For example, the initial groove 1701 can be formed in a similar manner as illustrated and described relative to FIG. 9. In some embodiments, the scoring device 901 (e.g., illustrated in FIG. 9) can score the first exposed region 1503 and/or the second exposed region 1505 to form the initial groove 1701. The scoring device 901 can comprise, for example, a scoring wheel, steel wool or sand sponge abrasion, etc. Following the formation of the initial groove 1701, the first exposed region 1503 and the second exposed region 1505 can be exposed to the etchant 521 (e.g., illustrated in FIG. 10) in a similar manner as illustrated and described relative to FIGS. 10-13. For example, the etchant 521 can etch the first exposed region 1503 and the second exposed region 1505 followed by applying a mechanical force to separate the first ribbon portion 1403 from the second ribbon portion 1405. In addition, the etching and the application of the mechanical force can form the first tapered edge 1201 at the first ribbon portion 1403 and the second tapered edge 1207 at the second ribbon portion 1405.

In some embodiments, the initial groove 1701 can be substantially continuous about the first ribbon portion 1403, the second ribbon portion 1405, the third ribbon portion 1407, and/or the fourth ribbon portion 1409. However, the initial groove 1701 may not be limited to extending continuously. For example, in some embodiments, the forming the initial groove 1701 can comprise directing the laser beam (e.g., the first laser beam 1507, the second laser beam 1511) towards the first exposed region 1503 to perforate the first exposed region 1503 at a plurality of locations to reduce an etch time of the first exposed region 1503 and the second exposed region 1505. For example, FIG. 18 illustrates an enlarged view of a portion of the glass ribbon 104 and the first mask 1401 taken at view 18 of FIG. 14 after the first exposed region 1503 has been exposed and the initial groove 1701 has been formed. In some embodiments, the initial groove 1701 can comprise a plurality of perforations 1801 at a plurality of locations, wherein the perforations 1801 may be separated from adjacent perforations 1801. In some embodiments, the perforations 1801 can extend partially or completely through the glass ribbon 104. The perforations 1801 can be formed by the laser ablating the first major surface 215. In some embodiments, the perforations 1801 are not limited to being formed in the first major surface 215, and, in addition or in the alternative, the perforations 1801 can be formed in the second major surface 216. Following the formation of the perforations 1801, the glass ribbon 104 can be etched in a similar manner as described above to separate the first ribbon portion 1403 from the second ribbon portion 1405 and form the first tapered edge 1201 and the second tapered edge 1207. Due to the perforations 1801 formed in the glass ribbon 104, an etch time of the glass ribbon 104 at the initial groove 1701 may be reduced. In some embodiments, the forming the initial groove 1901 can comprise perforating the first major surface 215 at a plurality of locations (e.g., the perforations 1801) between a first ribbon portion 1903 and a second ribbon portion 1905. For example, the forming the initial groove 1901 can comprise perforating the first exposed region 1503 at a plurality of locations (e.g., the perforations 1801) to reduce the etch time of the first exposed region 1503 and the second exposed region 1505.

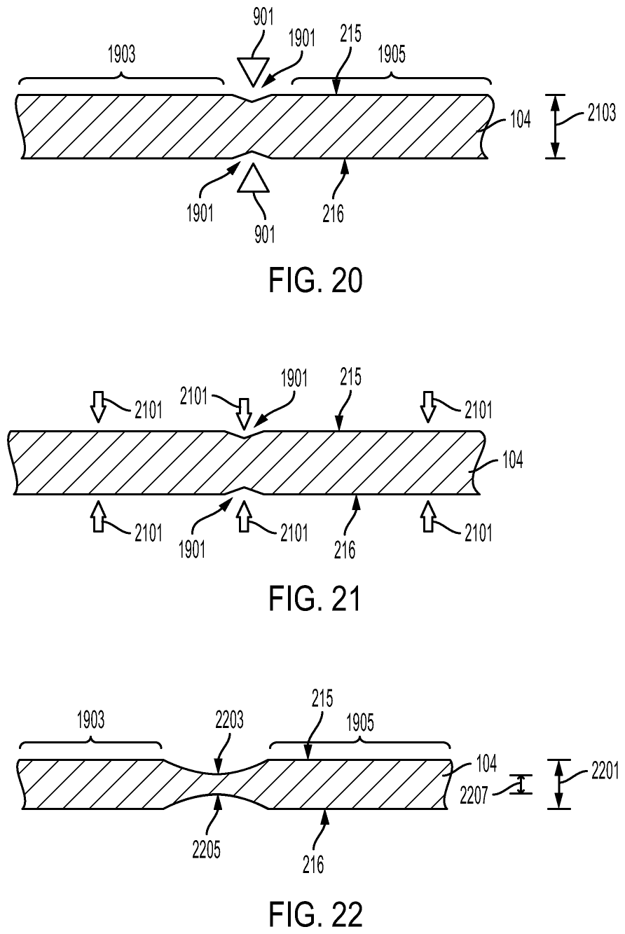

Referring to FIG. 19, further embodiments of methods of manufacturing the glass ribbon 104 are illustrated. In some embodiments, an initial groove 1901 can be formed in the glass ribbon 104. The glass ribbon 104 can initially be unmasked, for example, with the first major surface 215 and the second major surface 216 substantially exposed. For example, referring to FIG. 20, a sectional view of the glass ribbon 104 is illustrated along line 20-20 of FIG. 19. In some embodiments, methods of manufacturing the glass ribbon 104 can comprise forming, prior to etching, the initial groove 1901 at one or more of the first major surface 215 of the glass ribbon 104 or the second major surface 216 of the glass ribbon. The initial groove 1901 can be formed between the first ribbon portion 1903 of the glass ribbon 104 and the second ribbon portion 1905 of the glass ribbon 104. In some embodiments, the initial groove 1901 can be formed in the first major surface 215 and not the second major surface 216. In some embodiments, the initial groove 1901 can be formed in the second major surface 216 and not the first major surface 215. The initial groove 1901 can be formed in several ways. For example, in some embodiments, the forming the initial groove 1901 can comprise scoring the first major surface 215 between the first ribbon portion 1903 and the second ribbon portion 1905. In some embodiments, the scoring device 901 can score the first major surface 215 and/or the second major surface 216 to form the initial groove 1901. In some embodiments, the forming the initial groove 1901 can comprise perforating the first major surface 215 to form the perforations 1801 (e.g., as illustrated in FIG. 18). In some embodiments, prior to the glass ribbon 104 being exposed to an etchant 2101, the glass ribbon 104 can comprise an initial thickness 2103.

Referring to FIG. 21, in some embodiments, the glass ribbon 104 can be exposed to the etchant 2101. For example, due to the glass ribbon 104 being unmasked, the first major surface 215 and the second major surface 216 can be exposed to the etchant 2101. In some embodiments, the etchant 2101 can comprise one or more of from about 0% to about 50% HF, a combination of HF and HNO₃, HₛSO₄, etc. Due to the etchant 2101 contacting the first major surface 215, the second major surface 216, and the initial groove 1901, a thickness of the glass ribbon 104 can be reduced. In some embodiments, the initial thickness 2103 of the glass ribbon 104, prior to being exposed to the etchant 2101, can be greater than about 200 μm. For example, the initial thickness 2103 can be within a range from about 400 μm to about 700 μm, or within a range from about 500 μm to about 600 μm. In some embodiments, the initial thickness 2103 may be larger than a final target thickness due to the subsequent exposure of the glass ribbon 104 to the etchant 2101 reducing a thickness of the glass ribbon 104.

Referring to FIG. 22, in some embodiments, glass ribbon 104 can be exposed to the etchant 2101 for a period of time. For example, etching the glass ribbon 104 can comprise exposing the first major surface 215 and the second major surface 216 to the etchant 2101 and concluding the exposure of the first major surface 215 and the second major surface 216 to the etchant 2101 prior to the first ribbon portion 1903 separating from the second ribbon portion 1905. Due to the first major surface 215 and the second major surface 216 being exposed to the etchant 2101, the thickness of the glass ribbon 104 can be reduced. For example, after a period of time has passed during which the first major surface 215 and the second major surface 216 may be exposed to the etchant 2101, a secondary thickness 2201 of the glass ribbon 104 can be less than the initial thickness 2103. In some embodiments, the first major surface 215 can comprise a first groove surface 2203 that corresponds to an initial location of the initial groove 1901 in the first major surface 215. In some embodiments, the second major surface 216 can comprise a second groove surface 2205 that corresponds to an initial location of the initial groove 1901 in the second major surface 216. A minimum distance 2207 can be defined between the first groove surface 2203 and the second groove surface 2205, wherein the minimum distance 2207 can define a minimum thickness of the glass ribbon 104. By concluding the exposure of the first major surface 215 and the second major surface 216 to the etchant 2101 prior to the first ribbon portion 1903 separating from the second ribbon portion 1905, the first ribbon portion 1903 may remain attached to the second ribbon portion 1905. In some embodiments, the formation of the initial groove 1901 can reduce the etch time of the glass ribbon 104.

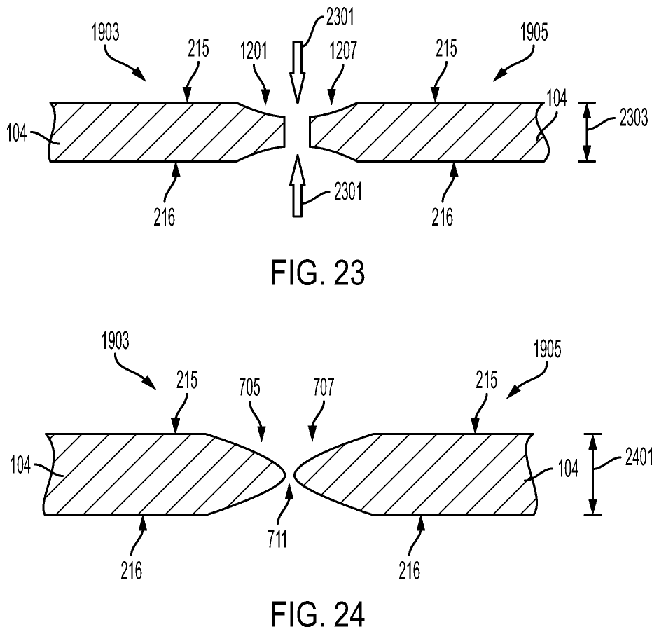

Referring to FIG. 23, in some embodiments, methods of manufacturing the glass ribbon 104 can comprise applying a mechanical force to the glass ribbon 104 to separate the first ribbon portion 1903 from the second ribbon portion 1905 after concluding the exposure of the first major surface 215 and the second major surface 216 to the etchant 2101. For example, the mechanical force can be applied using an ultrasonic vibration, or other types of vibration, for example, uneven rolls, thermal shock, air bursts, etc. Due to the minimum distance 2207 (e.g., illustrated in FIG. 22) between the first groove surface 2203 and the second groove surface 2205 being less than the secondary thickness 2201 of the glass ribbon 104, the mechanical force can cause the glass ribbon 104 to break at the first groove surface 2203 and the second groove surface 2205, wherein a crack can propagate through the glass ribbon 104 between the first ribbon portion 1903 and the second ribbon portion 1905. In some embodiments, the mechanical force can be great enough to cause the glass ribbon 104 to break at the first groove surface 2203 and the second groove surface 2205, but small enough to not cause the glass ribbon 104 to break at other locations, for example, the thicker areas of the glass ribbon 104 that comprise the secondary thickness 2201. Following the separation of the first ribbon portion 1903 from the second ribbon portion 1905, the first ribbon portion 1903 can comprise the first tapered edge 1201 while the second ribbon portion 1905 can comprise the second tapered edge 1207. In some embodiments, the first tapered edge 1201 and the second tapered edge 1207 can be substantially similar to the first tapered edge 1201 and the second tapered edge 1207 that are illustrated and described relative to FIG. 12. In some embodiments, similar to the embodiments illustrated and described relative to FIG. 13, the first ribbon portion 1903 and the second ribbon portion 1905 can be exposed to a second etchant 2301. In some embodiments, the second etchant 2301 can be similar to the etchant 2101 and may comprise one or more of from about 0% to about 50% HF, a combination of HF and HNO₃, HₛSO₄, etc., though, in some embodiments, the second etchant 2301 can comprise a different material than the etchant 2101. Exposing the first ribbon portion 1903 and the second ribbon portion 1905 to the second etchant 2301 can, in some embodiments, remove defects on the surfaces of the first ribbon portion 1903 and/or the second ribbon portion 1905.

In some embodiments, methods of manufacturing the glass ribbon 104 can comprise etching the glass ribbon 104 to reduce a thickness of the glass ribbon 104 and separate the first ribbon portion 1903 from the second ribbon portion 1905 along the initial groove 1901 such that the first tapered edge 1201 may be formed at the first ribbon portion 1903 and the second tapered edge 1207 may be formed at the second ribbon portion 1905. For example, due to the glass ribbon 104 being unmasked during the etching (e.g., illustrated in FIGS. 21-23), the thickness of the glass ribbon 104 can be reduced as a result of the exposure of the first major surface 215 and the second major surface 216 to the etchant 2101 and/or the second etchant 2301. In some embodiments, the first ribbon portion 1903 and the second ribbon portion 1905 can comprise a final thickness 2303 that may be less than the initial thickness 2103 (e.g., illustrated in FIG. 21) and the secondary thickness 2201 (e.g., illustrated in FIG. 22). For example, the final thickness 2303 can be within a range from about 20 μm to about 200 μm or within a range from about 25 μm to about 125 μm. Accordingly, the glass ribbon 104 can initially comprise a larger than target thickness (e.g., the initial thickness 2103), and, following the etching, the glass ribbon 104 can comprise a target thickness (e.g., the final thickness 2303) due to the exposure of the first major surface 215 and/or the second major surface 216 to the etchant 2101 and/or the second etchant 2301.

Referring to FIG. 24, in some embodiments, methods of manufacturing the glass ribbon 104 are not limited to concluding the exposure of the first major surface 215 and the second major surface 216 to the etchant 2101 prior to the first ribbon portion 1903 separating from the second ribbon portion 1905. Rather, similar to the embodiments illustrated and described relative to FIGS. 5-8, etching the glass ribbon 104 can comprise exposing the first major surface 215 and the second major surface 216 to the etchant 2101 for a period of time until the first ribbon portion 1903 may be separated from the second ribbon portion and the gap 711 may be formed between the first tapered edge 705 of the first ribbon portion 1903 and the second tapered edge 707 of the second ribbon portion 1905. In some embodiments, methods of manufacturing the glass ribbon 104 can comprise etching the glass ribbon 104 to reduce the thickness of the glass ribbon 104 and separate the first ribbon portion 1903 from the second ribbon portion 1905 along the initial groove 1901 such that the first tapered edge 705 may be formed at the first ribbon portion 1903 and the second tapered edge 707 may be formed at the second ribbon portion 1905. For example, due to the glass ribbon 104 being unmasked during the etching (e.g., illustrated in FIGS. 21-23), the thickness of the glass ribbon 104 can be reduced as a result of the exposure of the first major surface 215 and the second major surface 216 to the etchant 2101. In some embodiments, the first ribbon portion 1903 and the second ribbon portion 1905 can comprise a final thickness 2401 that may be less than the initial thickness 2103 (e.g., illustrated in FIG. 21) and the secondary thickness 2201 (e.g., illustrated in FIG. 22). For example, the final thickness 2401 can be within a range from about 20 μm to about 200 μm or within a range from about 25 μm to about 125 μm. Accordingly, the glass ribbon 104 can initially comprise a larger than target thickness (e.g., the initial thickness 2103), and, following the etching, the glass ribbon 104 can comprise a target thickness (e.g., the final thickness 2303) due to the exposure of the first major surface 215 and/or the second major surface 216 to the etchant 2101.

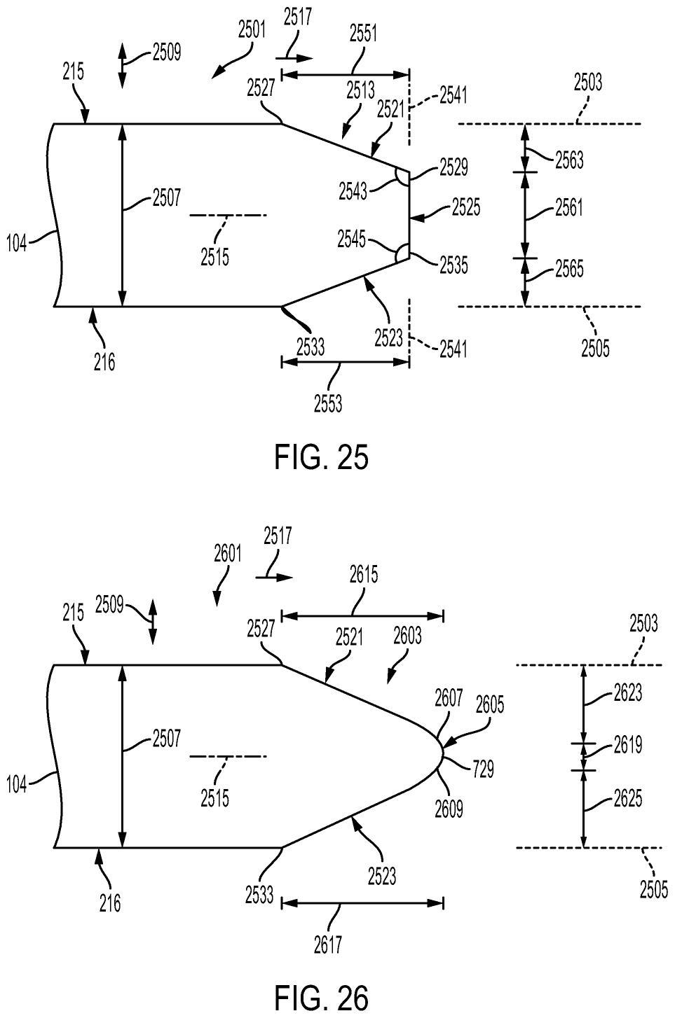

Referring to FIG. 25, some embodiments of one or more of the ribbon portions 701, 703, 1903, 1905 are illustrated. In some embodiments, a ribbon portion 2501 can be formed in a similar manner to the first ribbon portion 701 and/or the second ribbon portion 703 of FIG. 12, or the first ribbon portion 1903 and/or the second ribbon portion 1905 of FIG. 23. The ribbon portion 2501 can be formed from the glass ribbon 104 illustrated in FIG. 3, and may be substantially similar to the first ribbon portion 701, the second ribbon portion 703, the first ribbon portion 1903, and/or the second ribbon portion 1905. In some embodiments, the ribbon portion 2501 of the glass ribbon 104 can be unmasked to expose the first major surface 215 and the second major surface 216. The ribbon portion 2501 can be unmasked in several ways, for example, by rinsing the mask from the first major surface 215 and/or the second major surface 216. In some embodiments, a liquid can be directed towards the first major surface 215 and the second major surface 216 to remove a mask (e.g., the first mask 401) from the first major surface 215 and a mask (e.g., the fifth mask 501) from the second major surface 216. In some embodiments, a pressurized liquid can be directed at a sufficient velocity to unmask the ribbon portion 2501.

In some embodiments, the ribbon portion 2501 can comprise the first major surface 215 extending along a first plane 2503 and the second major surface 216 extending along a second plane 2505 substantially parallel to the first plane 2503. The ribbon portion 2501 of the glass ribbon 104 can comprise a first thickness 2507 that may be defined between the first major surface 215 and the second major surface along a thickness direction 2509 perpendicular to the first major surface 215. In some embodiments, the first thickness 2507 can be substantially similar to the final thickness 751 (e.g., illustrated in FIG. 7) or the final thickness 2303 (e.g., illustrated in FIG. 23) of the glass ribbon 104. For example, the first thickness 2507 can be within a range from about 20 μm to about 200 μm, or within a range from about 25 μm to about 125 μm.

The ribbon portion 2501 can comprise a tapered edge 2513. In some embodiments, the tapered edge 2513 can be substantially similar to the first tapered edge 1201 and/or the second tapered edge 1207 illustrated in FIGS. 13 and 23. For example, the tapered edge 2513 can comprise a thickness that decreases along a first axis 2515, which may be parallel to the first major surface 215 and the second major surface of the ribbon portion 2501, in a first direction 2517 from a center of the ribbon portion 2501 towards a perimeter of the ribbon portion 2501. While FIG. 25 illustrates one edge (e.g., the tapered edge 2513) of the ribbon portion 2501, the remaining edges of the ribbon portion 2501 may be substantially similar in size and shape to the tapered edge 2513 illustrated in FIG. 25, wherein the remaining edges of the ribbon portion 2501 may be tapered similar to the tapered edge 2513.

In some embodiments, the ribbon portion 2501 can comprise a first intermediate surface 2521, a second intermediate surface 2523, and an edge surface 2525. The first intermediate surface 2521 can extend between a first outer edge 2527 of the first major surface 215 and a first outer edge 2529 of the edge surface 2525. In some embodiments, the first intermediate surface 2521 can be substantially planar though, the first intermediate surface 2521 is not so limited and in some embodiments, the first intermediate surface 2521 can be non-planar (e.g., as illustrated in FIG. 26). The first intermediate surface 2521 may be non-parallel to the first major surface 215, and, in some embodiments, the first intermediate surface 2521 may be non-parallel with the second intermediate surface 2523. For example, the second intermediate surface 2523 can extend between a first outer edge 2533 of the second major surface 216 and a second outer edge 2535 of the edge surface 2525. The second intermediate surface 2523 can be substantially planar, though, the second intermediate surface 2523 is not so limited, and in some embodiments, the second intermediate surface 2523 can be non-planar (e.g., as illustrated in FIG. 26). The second intermediate surface 2523 can extend non-parallel to the second major surface 216. In some embodiments, an axis can intersect the first outer edge 2527 of the first major surface 215 and the first outer edge 2533 of the second major surface 216, with the axis substantially perpendicular to the first major surface 215 and the second major surface 216, and the axis substantially parallel to the thickness direction 2509.

In some embodiments, the edge surface 2525 can extend between the first plane 2503 and the second plane 2505. For example, by extending between the first plane 2503 and the second plane 2505, the edge surface 2525 can extend non-parallel to the first plane 2503 and the second plane 2505. In some embodiments, the edge surface 2525 can extend along an edge plane 2541 that may be substantially perpendicular to the first plane 2503 and/or the second plane 2505, wherein the edge plane 2541 can intersect the first plane 2503 and the second plane 2505. The edge surface 2525, extending between the first plane 2503 and the second plane 2505 along the edge plane 2541 that may be substantially perpendicular to the first plane 2503, can define an outer boundary of the ribbon portion 2501. For example, the first intermediate surface 2521 and the second intermediate surface 2523 can taper and converge from the first major surface 215 and the second major surface 216 towards the edge surface 2525. In some embodiments, the first intermediate surface 2521 can define a first angle 2543 relative to the edge surface 2525. In some embodiments, the first angle 2543 may be within a range from about 90 degrees to about 170 degrees. In some embodiments, the second intermediate surface 2523 can define a second angle 2545 relative to the edge surface 2525. In some embodiments, the second angle 2545 may be within a range from about 90 degrees to about 170 degrees. In some embodiments, the first angle 2543 may be substantially equal to the second angle 2545.

In some embodiments, a first separating length 2551 between the first outer edge 2527 of the first major surface 215 and the edge plane 2541 in a direction parallel to the first major surface 215 may be within a range from about 5 μm to about 85 μm. In some embodiments, a second separating length 2553 between the first outer edge 2533 of the second major surface 216 and the edge plane 2541 in a direction parallel to the second major surface 216 may be within a range from about 5 μm to about 85 μm. In some embodiments, the first separating length 2551 may be substantially equal to the second separating length 2553. In some embodiments, the edge surface 2525 can comprise a height 2561 in the thickness direction 2509 that may be less than the first thickness 2507. For example, in some embodiments, the height 2561 may be within a range from about 25 μm to about 75 μm. In some embodiments, the edge surface 2525 can be spaced a first separating thickness 2563 from the first plane 2503 from the first plane 2503 and a second separating thickness 2565 from the second plane 2505. For example, the first separating thickness 2563 between the first outer edge 2529 of the edge surface 2525 and the first plane 2503 along a direction parallel to the edge plane 2541 may be within a range from about 25 μm to about 100 μm. In some embodiments, the second separating thickness 2565 between the second outer edge 2535 of the edge surface 2525 and the second plane 2505 along the direction parallel to the edge plane 2541 may be within a range from about 25 μm to about 100 μm. In some embodiments, the first separating thickness 2563 may be substantially equal to the second separating thickness 2565. However, the first separating thickness 2563 is not limited to being equal to the second separating thickness 2565, and in some embodiments, the first separating thickness 2563 may be greater than the second separating thickness 2565, or the first separating thickness 2563 may be less than the second separating thickness 2565.

Referring to FIG. 26, further embodiments of one or more of the ribbon portions 701, 703, 1903, 1905 are illustrated. In some embodiments, a ribbon portion 2601 can be formed in a similar manner as the first ribbon portion 701 and/or the second ribbon portion 703 of FIG. 7, or the first ribbon portion 1903 and/or the second ribbon portion 1905 of FIG. 24. The ribbon portion 2601 can be formed from the glass ribbon 104 illustrated in FIG. 3, and may be substantially similar to the first ribbon portion 701, the second ribbon portion 703, the first ribbon portion 1903, and/or the second ribbon portion 1905. In some embodiments, the ribbon portion 2601 of the glass ribbon 104 can be unmasked to expose the first major surface 215 and the second major surface 216. The ribbon portion 2601 can be unmasked in several ways, for example, by rinsing the mask from the first major surface 215 and/or the second major surface 216. In some embodiments, a liquid can be directed towards the first major surface 215 and the second major surface 216 to remove a mask (e.g., the first mask 401) from the first major surface 215 and a mask (e.g., the fifth mask 501) from the second major surface 216. In some embodiments, a pressurized liquid can be directed at a sufficient velocity to unmask the ribbon portion 2601. In some embodiments, the ribbon portion 2601 can comprise the first major surface 215 extending along the first plane 2503 and the second major surface 216 extending along the second plane 2505 substantially parallel to the first plane 2503. The first thickness 2507 may be defined between the first major surface 215 and the second major surface 216.

In some embodiments, the ribbon portion 2601 can comprise a tapered edge 2603. The tapered edge 2603 can be substantially similar to the first tapered edge 705 and/or the second tapered edge 707 illustrated in FIGS. 7 and 24. For example, the tapered edge 2603 can comprise a thickness that decreases along the first axis 2515 in the first direction 2517 from the center of the ribbon portion 2601 towards a perimeter of the ribbon portion 2601. While FIG. 26 illustrates one edge (e.g., the tapered edge 2603) of the ribbon portion 2601, the remaining edges of the ribbon portion 2601 may be substantially similar in size and shape to the tapered edge 2603 illustrated in FIG. 26, wherein the remaining edges of the ribbon portion 2601 may be tapered similar to the tapered edge 2603.

In some embodiments, the ribbon portion 2601 can comprise the first intermediate surface 2521, the second intermediate surface 2523, and an edge surface 2605. The first intermediate surface 2521 can extend between the first outer edge 2527 of the first major surface 215 and a first outer edge 2607 of the edge surface 2605. The second intermediate surface 2523 can extend between the first outer edge 2533 of the second major surface 216 and a second outer edge 2609 of the edge surface 2605. In some embodiments, the edge surface 2605 can extend between the first plane 2503 and the second plane 2505. The edge surface 2605 can be non-planar, for example, by comprising a rounded, circular shape. The edge surface 2605 can comprise the first outer boundary 729 that can define an outermost location from a center of the ribbon portion 2601. In some embodiments, the edge surface 2605 can comprise a radius of curvature that may be less than about half of the first thickness 2507. For example, the radius of curvature may be within a range of from about 5 μm to about 100 μm. The ribbon portion 2601 can comprise a first separating length 2615 between the first outer edge 2527 of the first major surface 215 and the first outer boundary 729 of the edge surface 2605 in a direction parallel to the first major surface 215 that may be within a range from about 5 μm to about 85 μm. The ribbon portion 2601 can comprise a second separating length 2617 between the first outer edge 2533 of the second major surface 216 and the first outer boundary 729 of the edge surface 2605 in a direction parallel to the second major surface 216 that may be within a range from about 5 μm to about 85 μm. In some embodiments, the first separating length 2615 may be substantially equal to the second separating length 2617. In some embodiments, the edge surface 2605 can comprise a height 2619 in the thickness direction 2509 that may be less than the first thickness 2507. For example, the height 2619 of the edge surface 2605 can be between the first outer edge 2607 of the edge surface 2605 and the second outer edge 2609 of the edge surface 2605. In some embodiments, the height 2619 may be within a range from about 25 μm to about 75 μm. The edge surface 2605 can be spaced a first separating thickness 2623 from the first plane 2503 and a second separating thickness 2625 from the second plane 2505. For example, the first separating thickness 2623 between the first outer edge 2607 of the edge surface 2605 and the first plane 2503 along the thickness direction 2509 may be within a range of from about 25 μm to about 100 μm. In some embodiments, the second separating thickness 2625 between the second outer edge 2609 of the edge surface 2605 and the second plane 2505 along the thickness direction 2509 may be within a range of from about 25 μm to about 100 μm. In some embodiments, the first separating thickness 2623 may be substantially equal to the second separating thickness 2625. However, the first separating thickness 2623 is not limited to being equal to the second separating thickness 2625, and in some embodiments, the first separating thickness 2623 may be greater than the second separating thickness 2625, or the first separating thickness 2623 may be less than the second separating thickness 2625.

In some embodiments, following the formation of the ribbon portions 701, 703, 1403, 1405, 1903, 1905, 2501, 2601 comprising the tapered edges 705, 707, 1201, 1207, 2513, 2603, the ribbon portions 701, 703, 1403, 1405, 1903, 1905, 2501, 2601 can be exposed to a strengthening bath. The strengthening bath can generate compressive stress regions along one or more surfaces of the ribbon portions 701, 703, 1403, 1405, 1903, 1905, 2501, 2601. The ribbon portions 701, 703, 1403, 1405, 1903, 1905, 2501, 2601 can be exposed to the strengthening bath in several ways. In some embodiments, the ribbon portions 701, 703, 1403, 1405, 1903, 1905, 2501, 2601 can be immersed in a tank comprising the strengthening bath. In some embodiments, the ribbon portions 701, 703, 1403, 1405, 1903, 1905, 2501, 2601 can be sprayed with a strengthening bath solution to generate the compressive stress regions. Following the generation of the compressive stress regions, a protective covering can be applied to one or more surfaces of the ribbon portions 701, 703, 1403, 1405, 1903, 1905, 2501, 2601.

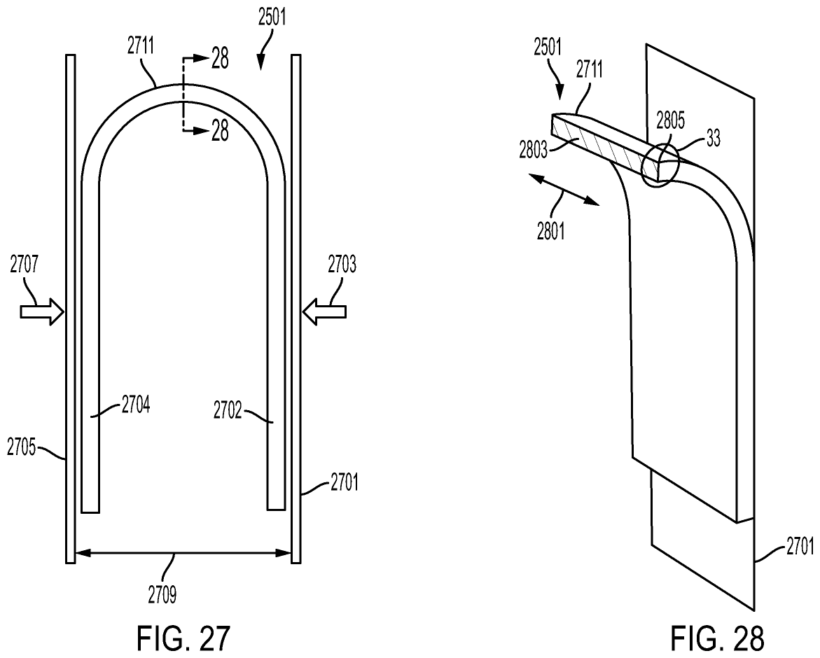

FIG. 27 illustrates the ribbon portion 2501 subject to a bending test to determine a stress at different locations of the ribbon portion 2501. For example, a first plate 2701 can contact a first planar segment 2702 of the ribbon portion 2501 and apply a first force 2703 to the ribbon portion 2501 in a first direction. A second plate 2705 can contact a second planar segment 2704 of the ribbon portion 2501 and apply a second force 2707 to the ribbon portion 2501 in a second direction that is opposite the first direction. In some embodiments, the first plate 2701 and the second plate 2705 can be oriented substantially parallel to each other, and may be spaced a distance 2709 apart. The ribbon portion 2501 can comprise a bent segment 2711 extending between the first planar segment 2702 and the second planar segment 2704. In some embodiments, the bent segment 2711 can be non-planar and may comprise a curved shape. By increasing the first force 2703 and/or the second force 2707, the distance 2709 between the first plate 2701 and the second plate 2705 can be increased or decreased. In some embodiments, the distance 2709 can be decreased to determine a maximum degree of bending that the ribbon portion 2501 can undergo prior to failing. Referring to FIG. 28, a sectional view of the ribbon portion 2501 along line 28-28 of FIG. 27 is illustrated. In some embodiments, the ribbon portion 2501 can experience a maximum stress at the bent segment 2711. For example, the maximum stress can be located at an outer surface of the bent segment 2711. In some embodiments, the maximum stress can vary based on a location along a width direction 2801 of the bent segment 2711. For example, the maximum stress at a central location 2803 of the bent segment 2711 can be different than the maximum stress at an edge location 2805 of the bent segment 2711. The central location 2803 can be located at a midpoint of the ribbon portion 2501 between opposing edges along the width direction 2801, while the edge location 2805 can be located at an edge of the ribbon portion 2501 along the width direction 2801.

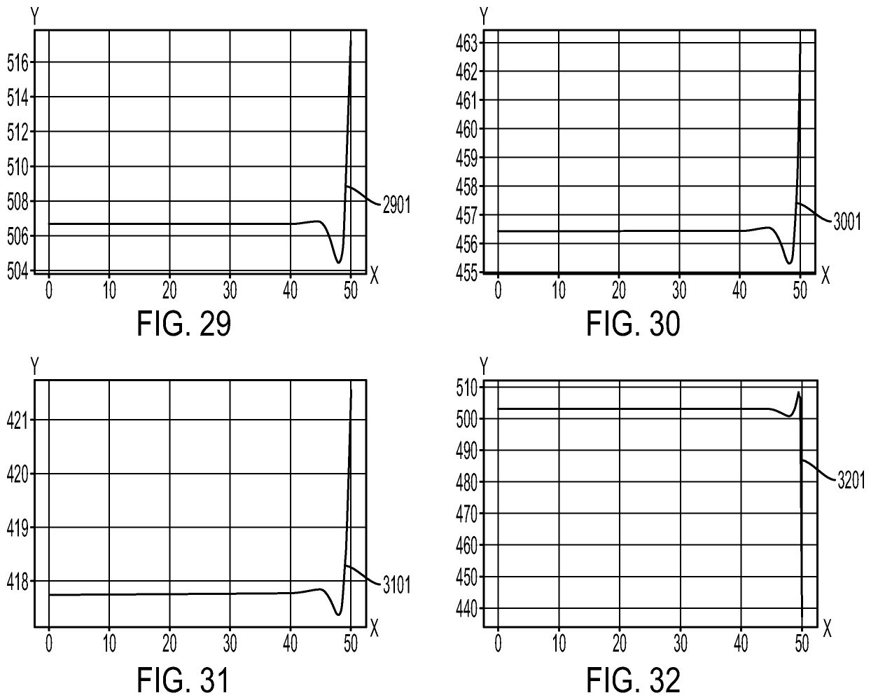

FIG. 29 illustrates a relationship between a location along the width of the bent segment 2711 in the width direction 2801 and a maximum stress at that location. The x-axis (e.g., horizontal axis) represents the distance (e.g., μm) from the central location 2803 along the width direction 2801 while the y-axis (e.g., vertical axis) represents the maximum stress (e.g., megapascals, “MPa”). A line 2901 represents a maximum stress of the bent segment 2711 at a location between the central location 2803 and the edge location 2805. In some embodiments, the line 2901 is representative of the ribbon portion 2501 comprising an edge that is non-tapered (e.g., wherein a thickness of the ribbon portion 2501 is constant from a center to an edge), and the first thickness 2507 may be about 100 μm. The 0 μm distance on the x-axis is representative of the maximum stress at the central location 2803, while the 50 μm distance on the x-axis is representative of the maximum stress at the edge location 2805. The other locations on the x-axis between the 0 μm distance and the 50 μm distance (e.g., 10 μm, 20 μm, 30 μm, 40 μm, etc.) are representative of the maximum stress of the bent segment 2711 at locations between the central location 2803 and the edge location 2805 along the width direction 2801. For example, the 10 μm location may represent a location that may be 10 μm from the central location 2803 and 40 μm from the edge location 2805 along the width direction 2801. The 20 μm location may represent a location that may be 20 μm from the central location 2803 and 30 μm from the edge location 2805 along the width direction 2801. The 30 μm location may represent a location that may be 30 μm from the central location 2803 and 20 μm from the edge location 2805 along the width direction 2801. The 40 μm location may represent a location that may be 40 μm from the central location 2803 and 10 μm from the edge location 2805 along the width direction 2801. In some embodiments, as represented by the line 2901, the maximum stress of the bent segment 2711 can be substantially constant from the 0 μm location (e.g., at the central location 2803) to the 40 μm location, with the maximum stress within a range from about 506 MPa to about 507 MPa. The maximum stress may decrease at about the 45 μm location, in which the maximum stress reaches a minimum of about 505 MPa. After reaching this minimum, the maximum stress increases from the 45 μm location to the 50 μm location (e.g., at the edge location 2805), with the maximum stress exceeding 517 MPa. This increase in maximum stress from the central location 2803 to the edge location 2805 may be caused, in part, by the ribbon portion 2501 comprising a non-tapered edge when the first thickness 2507 of the ribbon portion 2501 may be about 100 μm.

FIG. 30 illustrates a relationship between a location along the width of the bent segment 2711 in the width direction 2801 and a maximum stress at that location. The x-axis (e.g., horizontal axis) represents the distance (e.g., μm) from the central location 2803 along the width direction 2801 while the y-axis (e.g., vertical axis) represents the maximum stress (e.g., mega-pascals, “MPa”). A line 3001 represents a maximum stress of the bent segment 2711 at a location between the central location 2803 and the edge location 2805. In some embodiments, the line 3001 is representative of the ribbon portion 2501 comprising an edge that is non-tapered (e.g., wherein a thickness of the ribbon portion 2501 is constant from a center to an edge), and the first thickness 2507 is about 75 μm. The 0 μm distance on the x-axis is representative of the maximum stress at the central location 2803, while the 50 μm distance on the x-axis is representative of the maximum stress at the edge location 2805. The other locations on the x-axis between the 0 μm distance and the 50 μm distance (e.g., 10 μm, 20 μm, 30 μm, 40 μm, etc.) are representative of the maximum stress of the bent segment 2711 at locations between the central location 2803 and the edge location 2805 along the width direction 2801. For example, the 10 μm location may represent a location that may be 10 μm from the central location 2803 and 40 μm from the edge location 2805 along the width direction 2801. The 20 μm location may represent a location that may be 20 μm from the central location 2803 and 30 μm from the edge location 2805 along the width direction 2801. The 30 μm location may represent a location that may be 30 μm from the central location 2803 and 20 μm from the edge location 2805 along the width direction 2801. The 40 μm location may represent a location that is 40 μm from the central location 2803 and 10 μm from the edge location 2805 along the width direction 2801. In some embodiments, as represented by the line 3001, the maximum stress of the bent segment 2711 can be substantially constant from the 0 μm location (e.g., at the central location 2803) to the 40 μm location, with the maximum stress within a range from about 456 MPa to about 457 MPa. The maximum stress may decrease at about the 45 μm location, in which the maximum stress reaches a minimum of about 455.5 MPa. After reaching this minimum, the maximum stress increases from the 45 μm location to the 50 μm location (e.g., at the edge location 2805), with the maximum stress exceeding 462 MPa. This increase in maximum stress from the central location 2803 to the edge location 2805 may be caused, in part, by the ribbon portion 2501 comprising a non-tapered edge when the first thickness 2507 of the ribbon portion 2501 may be about 75 μm.

FIG. 31 illustrates a relationship between a location along the width of the bent segment 2711 in the width direction 2801 and a maximum stress at that location. The x-axis (e.g., horizontal axis) represents the distance (e.g., μm) from the central location 2803 along the width direction 2801 while the y-axis (e.g., vertical axis) represents the maximum stress (e.g., mega-pascals, “MPa”). A line 3101 represents a maximum stress of the bent segment 2711 at a location between the central location 2803 and the edge location 2805. In some embodiments, the line 3101 may be representative of the ribbon portion 2501 comprising an edge that may be non-tapered (e.g., wherein a thickness of the ribbon portion 2501 may be constant from a center to an edge), and the first thickness 2507 may be about 50 μm. The 0 μm distance on the x-axis may be representative of the maximum stress at the central location 2803, while the 50 μm distance on the x-axis may be representative of the maximum stress at the edge location 2805. The other locations on the x-axis between the 0 μm distance and the 50 μm distance (e.g., 10 μm, 20 μm, 30 μm, 40 μm, etc.) are representative of the maximum stress of the bent segment 2711 at locations between the central location 2803 and the edge location 2805 along the width direction 2801. For example, the 10 μm location may represent a location that may be 10 μm from the central location 2803 and 40 μm from the edge location 2805 along the width direction 2801. The 20 μm location may represent a location that may be 20 μm from the central location 2803 and 30 μm from the edge location 2805 along the width direction 2801. The 30 μm location may represent a location that may be 30 μm from the central location 2803 and 20 μm from the edge location 2805 along the width direction 2801. The 40 μm location may represent a location that may be 40 μm from the central location 2803 and 10 μm from the edge location 2805 along the width direction 2801. In some embodiments, as represented by the line 3101, the maximum stress of the bent segment 2711 can be substantially constant from the 0 μm location (e.g., at the central location 2803) to the 40 μm location, with the maximum stress within a range from about 417.5 MPa to about 418 MPa. The maximum stress may decrease at about the 45 μm location, in which the maximum stress reaches a minimum that may be within a range from about 417 MPa to about 417.5 MPa. After reaching this minimum, the maximum stress increases from the 45 μm location to the 50 μm location (e.g., at the edge location 2805), with the maximum stress exceeding 421 MPa. This increase in maximum stress from the central location 2803 to the edge location 2805 may be caused, in part, by the ribbon portion 2501 comprising a non-tapered edge when the first thickness 2507 of the ribbon portion 2501 may be about 75 μm.

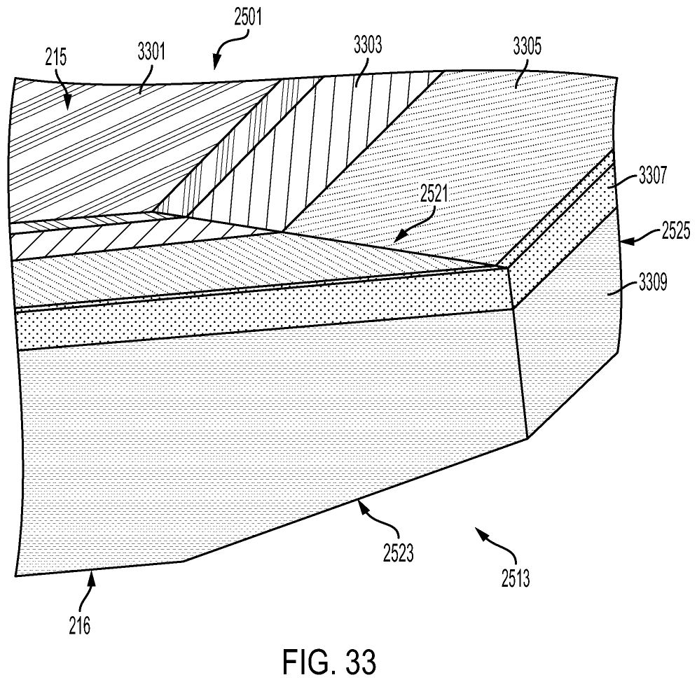

FIG. 32 illustrates a relationship between a location along the width of the bent segment 2711 in the width direction 2801 and a maximum stress at that location. The x-axis (e.g., horizontal axis) represents the distance (e.g., μm) from the central location 2803 along the width direction 2801 while the y-axis (e.g., vertical axis) represents the maximum stress (e.g., mega-pascals, “MPa”). A line 3201 represents a maximum stress of the bent segment 2711 at a location between the central location 2803 and the edge location 2805. In some embodiments, the line 3201 may be representative of the ribbon portion 2501 comprising the tapered edge 2513, and the first thickness 2507 may be about 100 μm. The 0 μm distance on the x-axis may be representative of the maximum stress at the central location 2803, while the 50 μm distance on the x-axis may be representative of the maximum stress at the edge location 2805. The other locations on the x-axis between the 0 μm distance and the 50 μm distance (e.g., 10 μm, 20 μm, 30 μm, 40 μm, etc.) are representative of the maximum stress of the bent segment 2711 at locations between the central location 2803 and the edge location 2805 along the width direction 2801. For example, the 10 μm location may represent a location that may be 10 μm from the central location 2803 and 40 μm from the edge location 2805 along the width direction 2801. The 20 μm location may represent a location that may be 20 μm from the central location 2803 and 30 μm from the edge location 2805 along the width direction 2801. The 30 μm location may represent a location that may be 30 μm from the central location 2803 and 20 μm from the edge location 2805 along the width direction 2801. The 40 μm location may represent a location that may be 40 μm from the central location 2803 and 10 μm from the edge location 2805 along the width direction 2801. In some embodiments, as represented by the line 3201, the maximum stress of the bent segment 2711 can be substantially constant from the 0 μm location (e.g., at the central location 2803) to the 45 μm location, with the maximum stress within a range from about 500 MPa to about 505 MPa. The maximum stress may then increase at about the 48 μm location, in which the maximum stress reaches a maximum that may be within a range from about 505 MPa to about 510 MPa. After reaching this maximum, the maximum stress can decrease from the 48 μm location to the 50 μm location (e.g., at the edge location 2805), with the maximum stress falling below about 500 MPa and approaching 440 MPa.

The decrease in maximum stress from the central location 2803 to the edge location 2805 may be due, in part, to the ribbon portion 2501 comprising the tapered edge 2513 when the first thickness 2507 of the ribbon portion 2501 may be about 100 μm. In contrast to the ribbon portions that comprise a non-tapered edge (e.g., FIGS. 29-31) in which the maximum stress increases near the edge location 2805, the maximum stress for the ribbon portion 2501 comprising the tapered edge 2513 can decrease near the edge location 2805. For example, by comparing FIG. 29, in which the ribbon portion 2501 comprises a thickness of about 100 μm and does not comprise a tapered edge, to FIG. 32, which the ribbon portion 2501 comprises a thickness of about 100 μm and comprises the tapered edge 2513, the maximum stress at the tapered edge 2513 may be different. For example, the maximum stress at the non-tapered edge (e.g., the 50 μm location in FIG. 29) with 100 μm thickness may be about 516 MPa while the maximum stress at the tapered edge 2513 (e.g., the 50 μm location in FIG. 32) with 100 μm thickness may be about 440 MPa. This difference of about 76 MPa at the edge can allow for a reduced likelihood of damage to the ribbon portion 2501 during bending and also provide for a greater degree of bending for the ribbon portion 2501 when the ribbon portion 2501 comprises the tapered edge 2513. The maximum stress of the bent segment 2711 in FIG. 32 from 0 μm to 40 μm may differ slightly from the maximum stress of the bent segment 2711 in FIG. 29 from 0 μm to 40 μm, despite the thicknesses being about the same (e.g., about 100 μm). This may be due, in part, to the line 3201 representing the ribbon portion 2501 comprising the tapered edge 2513. In some embodiments, the tapered edge 2513 can lead to a reduction in surface area at both the first major surface 215 and the second major surface 216. This reduction in surface area can cause a slight decrease in maximum stress (e.g., from about 507 MPa in FIG. 29 to about 504 MPa in FIG. 32) at the center of the ribbon portion (e.g., from 0 μm to 40 μm).

FIG. 33 is an enlarged view of the tapered edge 2513 of the ribbon portion 2501 at the bent segment 2711 at view 33 of FIG. 28. For example, the second major surface 216 in FIG. 33 represents a bottom surface (e.g., or inner surface relative to a radius of curvature) of the bent segment 2711 of FIG. 28. The first major surface 215 in FIG. 33 represents a top surface (e.g., or outer surface relative to a radius of curvature) of the bent segment 2711 of FIG. 28. In some embodiments, the first thickness 2507 of the ribbon portion 2501 of FIG. 33 may be about 100 μm, while the height 2561 of the edge surface 2525 may be about 50 μm, and the distance 2709 (e.g., illustrated in FIG. 27) separating the first plate 2701 and the second plate 2705 may be about 30 μm. The ribbon portion 2501 illustrated in FIG. 33 is representative of a ribbon portion that has not been subject to chemical strengthening (e.g., via an ion exchange process).

In some embodiments, the ribbon portion 2501 can comprise a first stress region 3301 that extends along the first major surface 215. In some embodiments, the first stress region 3301 can comprise a stress (e.g., tensile stress) within a range from about 510 MPa to about 520 MPa. In some embodiments, the ribbon portion 2501 can comprise a second stress region 3303 that extends adjacent to the first stress region 3301. The second stress region 3303 can be spaced a distance apart from the first major surface 215, and the second stress region 3303 can comprise a portion of the first intermediate surface 2521. In some embodiments, the second stress region 3303 can comprise a stress (e.g., tensile stress) within a range from about 480 MPa to about 510 MPa. In some embodiments, the ribbon portion 2501 can comprise a third stress region 3305 that extends adjacent to the second stress region 3303, wherein the second stress region 3303 may be located between the first stress region 3301 and the third stress region 3305. The third stress region 3305 can be spaced a greater distance from the first major surface 215 than the second stress region 3303, and the third stress region 3305 can comprise a portion of the first intermediate surface 2521. In some embodiments, the third stress region 3305 can comprise a stress (e.g., tensile stress) within a range from about 440 MPa to about 480 MPa. In some embodiments, the ribbon portion 2501 can comprise a fourth stress region 3307 that extends adjacent to the third stress region 3305, wherein the third stress region 3305 may be located between the second stress region 3303 and the fourth stress region 3307. The fourth stress region 3307 can be spaced a greater distance from the first major surface 215 than the third stress region 3305, and the fourth stress region 3307 can comprise a portion of the first intermediate surface 2521 and a portion of the edge surface 2525. In some embodiments, the fourth stress region 3307 can comprise a stress (e.g., tensile stress) within a range from about 400 MPa to about 440 MPa. In some embodiments, the ribbon portion 2501 can comprise a fifth stress region 3309 that extends adjacent to the fourth stress region 3307, wherein the fourth stress region 3307 may be located between the third stress region 3305 and the fifth stress region 3309. The fifth stress region 3309 can be spaced a greater distance from the first major surface 215 than the fourth stress region 3307, and the fifth stress region 3309 can comprise a portion of the edge surface 2525, the second intermediate surface 2523, and the second major surface 216. In some embodiments, the fifth stress region 3309 can comprise a stress that may be less than about 400 MPa. For example, the fifth stress region 3309 can comprise a non-uniform stress in which a compressive stress of the fifth stress region 3309 may increase from the fourth stress region 3307 (e.g., or a center of the ribbon portion 2501) towards the second major surface 216. Due to the tapered edge 2513 of the ribbon portion 2501, the stress at the bent segment 2711 can decrease from a center of the ribbon portion 2501 towards the edge surface 2525. In some embodiments, the first major surface 215 may comprise a higher tensile stress (e.g., and lower compressive stress) than the second major surface 216, which may have a lower tensile stress (e.g., but higher compressive stress).

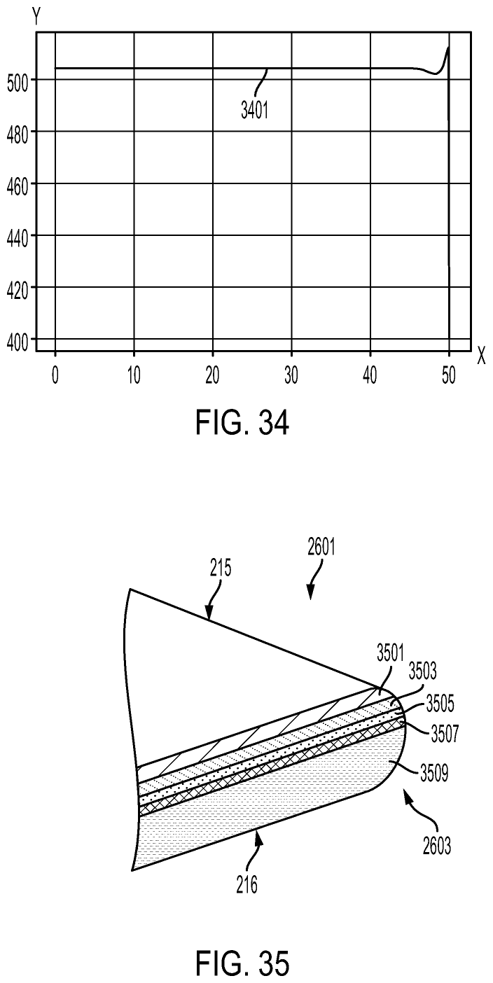

FIG. 34 illustrates a relationship between a location along the width of the bent segment 2711 (e.g., illustrated in FIG. 28) in the width direction 2801 and a maximum stress at that location. The x-axis (e.g., horizontal axis) represents the distance (e.g., μm) from the central location 2803 along the width direction 2801 while the y-axis (e.g., vertical axis) represents the maximum stress (e.g., mega-pascals, “MPa”). A line 3401 represents a maximum stress of the bent segment 2711 at a location between the central location 2803 and the edge location 2805. The line 3401 is representative of the ribbon portion 2601 comprising the tapered edge 2603 (e.g., illustrated in FIG. 26) comprising a radius of curvature of about 50 μm. For example, the ribbon portion 2601 may be positioned between the first plate 2701 and the second plate 2705 and bent (e.g., similar to the shape in FIG. 27), wherein the distance 2709 between the first plate 2701 and the second plate 2705 may be about 30 In some embodiments, the tapered edge 2603 comprises a rounded, half-circle shape between the first outer edge 2527 of the first major surface 215 and the first outer edge 2533 of the second major surface 216. The first thickness 2507 of the ribbon portion 2601 may be about 100 The 0 μm distance on the x-axis may be representative of the maximum stress at the central location 2803, while the 50 μm distance on the x-axis may be representative of the maximum stress at the edge location 2805. The other locations on the x-axis between the 0 μm distance and the 50 μm distance (e.g., 10 μm, 20 μm, 30 μm, 40 μm, etc.) are representative of the maximum stress of the bent segment 2711 at locations between the central location 2803 and the edge location 2805 along the width direction 2801. For example, the 10 μm location may represent a location that may be 10 μm from the central location 2803 and 40 μm from the edge location 2805 along the width direction 2801. The 20 μm location may represent a location that may be 20 μm from the central location 2803 and 30 μm from the edge location 2805 along the width direction 2801. The 30 μm location may represent a location that may be 30 μm from the central location 2803 and 20 μm from the edge location 2805 along the width direction 2801. The 40 μm location may represent a location that may be 40 μm from the central location 2803 and 10 μm from the edge location 2805 along the width direction 2801. In some embodiments, as represented by the line 3401, the maximum stress of the bent segment 2711 can be substantially constant from the 0 μm location (e.g., at the central location 2803) to the 45 μm location, with the maximum stress within a range from about 500 MPa to about 510 MPa. The maximum stress may then increase at about the 49 μm location, in which the maximum stress reaches a maximum that may be within a range from about 510 MPa to about 515 MPa. After reaching this maximum, the maximum stress can decrease from the 49 μm location to the 50 μm location (e.g., at the edge location 2805), with the maximum stress falling below about 500 MPa and approaching 400 MPa.

FIG. 35 is an enlarged view of the tapered edge 2603 of the ribbon portion 2601 at the bent segment 2711 at view 33 of FIG. 28 comprising maximum stresses represented by the line 3401 in FIG. 34. For example, the second major surface 216 in FIG. 35 represents a bottom surface (e.g., or inner surface relative to a radius of curvature) of the bent segment 2711 of FIG. 28. The first major surface 215 in FIG. 33 represents a top surface (e.g., or outer surface relative to a radius of curvature) of the bent segment 2711 of FIG. 28. In some embodiments, the first thickness 2507 of the ribbon portion 2601 may be about 100 μm, while the tapered edge 2603 may comprise a radius of curvature of about 50 μm. The ribbon portion 2601 illustrated in FIG. 33 is representative of a ribbon portion that has not been subject to chemical strengthening (e.g., via an ion exchange process).

In some embodiments, the ribbon portion 2601 can comprise a first stress region 3501 that extends along the first major surface 215. In some embodiments, the first stress region 3501 can comprise a stress (e.g., tensile stress) within a range from about 469 MPa to about 512 MPa. In some embodiments, the ribbon portion 2601 can comprise a second stress region 3503 that extends adjacent to the first stress region 3501. The second stress region 3503 can comprise a stress (e.g., tensile stress) within a range from about 427 MPa to about 469 MPa. In some embodiments, the ribbon portion 2601 can comprise a third stress region 3505 that extends adjacent to the second stress region 3503, wherein the second stress region 3503 may be located between the first stress region 3501 and the third stress region 3505. The third stress region 3505 can be spaced a greater distance from the first major surface 215 than the second stress region 3503. In some embodiments, the third stress region 3505 can comprise a stress (e.g., tensile stress) within a range from about 394 MPa to about 427 MPa. In some embodiments, the ribbon portion 2601 can comprise a fourth stress region 3507 that extends adjacent to the third stress region 3505, wherein the third stress region 3505 may be located between the second stress region 3503 and the fourth stress region 3507. The fourth stress region 3507 may be spaced a greater distance from the first major surface 215 than the third stress region 3505. In some embodiments, the fourth stress region 3507 can comprise a stress (e.g., tensile stress) within a range from about 0 MPa to about 394 MPa. In some embodiments, the ribbon portion 2601 can comprise a fifth stress region 3509 that extends adjacent to the fourth stress region 3507 and along the second major surface 216. In some embodiments, the fifth stress region 3509 can comprise a stress that may be less than about 0 MPa. The fifth stress region 3509 can comprise a non-uniform stress in which a compressive stress of the fifth stress region 3509 may increase from the fourth stress region 3507 (e.g., or a center of the ribbon portion 2601) towards the second major surface 216. Due to the tapered edge 2603 of the ribbon portion 2601 comprising a rounded, half-circle shape, the stress at the bent segment 2711 can decrease from a center of the ribbon portion 2601 towards the tapered edge 2603. In some embodiments, the first major surface 215 may comprise a higher tensile stress (e.g., and lower compressive stress) than the second major surface 216, which may have a lower tensile stress (e.g., but higher compressive stress).

As disclosed herein, the ribbon portions 701, 703, 1403, 1405, 1903, 1905, 2501, 2601 can be thin, for example, by comprising a thickness within a range from about 20 micrometers (μm) to about 200 μm or within a range from about 25 μm to about 125 μm. The ribbon portions 701, 703, 1403, 1405, 1903, 1905, 2501, 2601 can be formed in a continuous manner, in which a glass ribbon 104 can be separated into discrete ribbon portions (e.g., the ribbon portions 701, 703, 1403, 1405, 1903, 1905, 2501, 2601, etc.) with tapered edge shapes (e.g., tapered edges 705, 707, 1201, 1207, 2513, 2603). In some embodiments, the glass ribbon 104 can comprise an initial thickness that may either be a target thickness, or may be larger than a target thickness. In either scenario, the glass ribbon 104 can be separated into discrete ribbon portions with tapered edge shapes and a target thickness. The likelihood of damage to the ribbon portions (e.g., the ribbon portions 701, 703, 1403, 1405, 1903, 1905, 2501, 2601, etc.) may also be reduced due to a lack of grinding or polishing of the edges, and also due to a lack of stacking of the ribbon portions. By producing the tapered edges through chemical formation, sharp corners at the edges may also be avoided. The tapered edges 705, 707, 1201, 1207, 2513, 2603 of the ribbon portions 701, 703, 1403, 1405, 1903, 1905, 2501, 2601 can also reduce the likelihood of damage to the ribbon portions 701, 703, 1403, 1405, 1903, 1905, 2501, 2601 during bending. For example, during bending, the maximum stress at a bent segment of the ribbon portion 701, 703, 1403, 1405, 1903, 1905, 2501, 2601 may comprise a reduced stress near the tapered edge 705, 707, 1201, 1207, 2513, 2603 as compared to a ribbon portion with a non-tapered edge. Due to this lower stress near the tapered edge 705, 707, 1201, 1207, 2513, 2603, improved bending of the ribbon portion 701, 703, 1403, 1405, 1903, 1905, 2501, 2601 can be achieved. In addition, the lower stress near the tapered edge 705, 707, 1201, 1207, 2513, 2603 of the ribbon portion 701, 703, 1403, 1405, 1903, 1905, 2501, 2601 may improve the strength of the ribbon portion 701, 703, 1403, 1405, 1903, 1905, 2501, 2601, thus reducing the likelihood of inadvertent breakage, for example, during bending.

As used herein the terms “the,” “a,” or “an,” mean “one or more,” and should not be limited to “only one” unless explicitly indicated to the contrary. Thus, for example, reference to “a component” includes embodiments having two or more such components unless the context clearly indicates otherwise.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, for example within about 5% of each other, or within about 2% of each other.

As used herein, the terms “comprising” and “including,” and variations thereof shall be construed as synonymous and open-ended, unless otherwise indicated.

It should be understood that while various embodiments have been described in detail relative to certain illustrative and specific embodiments thereof, the present disclosure should not be considered limited to such, as numerous modifications and combinations of the disclosed features are envisioned without departing from the scope of the following claims.

What is claimed is:

1. A method of manufacturing a glass ribbon comprising:
masking a first region and a second region of a first major surface of the glass ribbon, such that the first major surface comprises a first exposed region between the first region and the second region;
masking a third region and a fourth region of a second major surface of the glass ribbon, such that the second major surface comprises a second exposed region between the third region and the fourth region; and
etching the first exposed region and the second exposed region to separate a first ribbon portion, comprising the first region and the third region, from a second ribbon portion, comprising the second region and the fourth region, and form a first tapered edge at the first ribbon portion and a second tapered edge at the second ribbon portion.

2. The method of claim 1, further comprising forming, prior to etching, an initial groove at the first exposed region.

3. The method of claim 2, wherein the forming the initial groove comprises one of: perforating the first exposed region at a plurality of locations; or scoring the first exposed region.

4. The method of claim 3, wherein the etching the first exposed region and the second exposed region comprises exposing the first exposed region and the second exposed region to an etchant and concluding an exposure of the first exposed region and the second exposed region to the etchant prior to the first ribbon portion separating from the second ribbon portion.

5. The method of claim 4, further comprising applying a mechanical force to the glass ribbon to separate the first ribbon portion from the second ribbon portion after concluding the exposure of the first exposed region and the second exposed region to the etchant, wherein the etching the first exposed region and the second exposed region comprises, following a separation of the first ribbon portion from the second ribbon portion, exposing the first tapered edge and the second tapered edge to a second etchant.

6. A method of manufacturing a glass ribbon comprising:
forming an initial groove at one or more of a first major surface of the glass ribbon or a second major surface of the glass ribbon, the initial groove formed between a first ribbon portion of the glass ribbon and a second ribbon portion of the glass ribbon; and
etching the glass ribbon to reduce a thickness of the glass ribbon and separate the first ribbon portion from the second ribbon portion along the initial groove such that a first tapered edge is formed at the first ribbon portion and a second tapered edge is formed at the second ribbon portion.

7. The method of claim 6, wherein the forming the initial groove comprises one of: perforating the first major surface at a plurality of locations between the first ribbon portion and the second ribbon portion; or scoring the first major surface between the first ribbon portion and the second ribbon portion.

8. The method of claim 6, wherein the etching the glass ribbon comprises exposing the first major surface and the second major surface to an etchant and concluding an exposure of the first major surface and the second major surface to the etchant prior to the first ribbon portion separating from the second ribbon portion, and further comprising applying a mechanical force to the glass ribbon to separate the first ribbon portion from the second ribbon portion after concluding the exposure of the first major surface and the second major surface to the etchant.

9. A method of manufacturing a glass ribbon comprising:
masking a first major surface and a second major surface of the glass ribbon;
unmasking a first exposed region of the first major surface and a second exposed region of the second major surface;
forming an initial groove at one or more of the first exposed region or the second exposed region, the initial groove formed between a first ribbon portion of the glass ribbon and a second ribbon portion of the glass ribbon; and
etching the first exposed region and the second exposed region to separate the first ribbon portion from the second ribbon portion along the initial groove and form a first tapered edge at the first ribbon portion and a second tapered edge at the second ribbon portion.

10. The method of claim 9, wherein the unmasking the first exposed region and the second exposed region comprises directing a laser beam towards a mask covering the first exposed region and a second mask covering the second exposed region.

11. The method of claim 10, wherein the forming the initial groove comprises one of: directing the laser beam towards the first exposed region to perforate the first exposed region at a plurality of locations; or scoring the first exposed region.

12. The method of claim 9, further comprising maintaining an initial thickness of the glass ribbon such that the initial thickness of the glass ribbon, defined between the first major surface and the second major surface at a first location spaced a distance apart from the first exposed region and the second exposed region, prior to etching is substantially equal to a final thickness of the first ribbon portion, defined between the first major surface and the second major surface at the first location, after etching, wherein the maintaining the initial thickness of the glass ribbon comprises maintaining the initial thickness within a range from about 20 μm to about 200 μm.

13. A glass ribbon comprising:
a first major surface extending along a first plane;
a second major surface extending along a second plane substantially parallel to the first plane, wherein a first thickness is defined between the first major surface and the second major surface along a thickness direction perpendicular to the first major surface, wherein the first thickness is within a range from about 25 μm to about 125 μm;
an edge surface extending between the first plane and the second plane along an edge plane that is substantially perpendicular to the first plane;
a first intermediate surface extending between a first outer edge of the first major surface and a first outer edge of the edge surface;
a second intermediate surface extending between a first outer edge of the second major surface and a second outer edge of the edge surface, wherein a first separating length between the first outer edge of the first major surface and the edge plane in a direction parallel to the first major surface is within a range from about 5 μm to about 85 μm and a first separating thickness between the first outer edge of the edge surface and the first plane along a direction parallel to the edge plane is within a range from about 25 μm to about 100 μm.

14. The glass ribbon of claim 13, wherein a second separating length between the first outer edge of the second major surface and the edge plane in a direction parallel to the second major surface is within a range from about 5 μm to about 85 μm.

15. The glass ribbon of claim 14, wherein the first separating length is substantially equal to the second separating length.

16. The glass ribbon of claim 15, wherein a second separating thickness between the second outer edge of the edge surface and the second plane along the direction parallel to the edge plane is within a range from about 25 μm to about 100 μm.

17. The glass ribbon of claim 16, wherein the first separating thickness is substantially equal to the second separating thickness.

18. The glass ribbon of claim 17, wherein the first intermediate surface is non-parallel with the second intermediate surface.

19. The glass ribbon of claim 18, wherein the edge surface comprises a height in the thickness direction that is less than the first thickness.
